(19) United States
(12) Patent Application Publication
(10) Pub. No.: US 2014/0340290 A1
(43) Pub. Date: Nov. 20, 2014

(54) DISPLAY DEVICE AND CONTROL METHOD THEREOF

(71) Applicant: Shinya Ono, Osaka (JP)

(72) Inventor: Shinya Ono, Osaka (JP)

(73) Assignee: PANASONIC CORPORATION, Osaka (JP)

(21) Appl. No.: 14/359,668

(22) PCT Filed: Nov. 24, 2011
(86) PCT No.: PCT/JP2011/006548

§ 371 Date: May 21, 2014

(51) Int. Cl. G09G 3/32

(52) U.S. Cl. CPC G09G 3/3233; G09G 2300/0842; G09G 2300/0852; G09G 2300/0861; G09G 2310/0262; G09G 2320/0233; G09G 2320/045
USPC 345/77

(57) ABSTRACT

Each of a plurality of pixel circuits included in the display device includes: a drive transistor; a first capacitive element having a first terminal connected to a source terminal of the drive transistor; a first switching element which switches between a gate terminal of the drive transistor and a data line; a second switching element which switches between a gate terminal of the drive transistor and a second terminal of the first capacitive element; a third switching element which switches between the second terminal of the first capacitive element and a reference voltage line; a fourth switching element which switches between a first power source line and the source terminal of the drive transistor; and a light-emitting element having a first terminal connected to a drain terminal of the drive transistor and having a second terminal connected to a second power source line.

### TECHNICAL FIELD

The present invention relates to display devices and control methods thereof, and particularly to a display device and a control method that use organic electroluminescence (EL) elements.

### BACKGROUND ART

Recent years have seen progress in the development and practical implementation of display devices (hereafter referred to as organic EL display devices) using organic EL elements. Generally, an organic EL display device includes (i) a display unit having, arranged in a matrix, pixel circuits each having an organic EL element, and (ii) a drive circuit for controlling the display unit.

A primitive pixel circuit used in active matrix type organic EL display device is configured by using an organic EL element, a switching transistor, a capacitor, and a drive transistor. In this pixel circuit, by first causing a selection switching transistor of the pixel to be conductive, by recording, from a signal line to a capacitor, a data voltage corresponding to a luminance signal of the pixel, and by causing the selection switching transistor to be non-conductive, the data voltage is held in the capacitor. Next, a current according to the magnitude of the voltage held in the capacitor is provided from the drive transistor to the organic EL element, and the organic EL element emits light corresponding to the current provided from the drive transistor.

With respect to the primitive pixel circuit, there is proposed a pixel circuit provided with a configuration for making organic EL elements emit light more precisely and stably, corresponding to the data voltage, and a control method thereof (for example, Patent Literature (PTL) 1).

FIG. 30 is a circuit diagram of a conventional pixel circuit 90 disclosed in PTL1.

The pixel circuit 90 includes transistors M1 to M5, capacitors Cvth and Cst, and an organic EL element OLED. A signal line Dm transmits a data voltage Vdata corresponding to light-emitting luminance of the organic EL element OLED.

The pixel circuit 90 roughly operates as follows. It should be noted that in the following description, an operation of applying voltage A to one of the ends of the capacitor and voltage B to the other end of the capacitor and then holding a voltage (A−B) which is a difference between voltage A and voltage B in the capacitor is referred that a voltage difference between A and B is held in the capacitor. This expression is used throughout the Description.

First, a voltage difference between VDD−Vth which is dropped from a source voltage of the transistor M1 (here, power source voltage VDD) to a threshold voltage Vth of the transistor M1 and a reference voltage Vsus is held in the capacitor Cvth. Next, a voltage difference between the data voltage Vdata and the power source voltage VDD is held in the capacitor Cst.

As a result, a voltage obtained by adding voltage Vsus−(VDD−Vth) held in the capacitor Cvth and voltage VDD−Vdata held in the capacitor Cst (that is, a voltage at both ends of a series circuit comprising capacitors Cvth and Cst) is voltage Vsus−Vdata+Vth obtained by adding the threshold voltage Vth to a difference between the reference voltage Vsus and the data voltage Vdata.

The voltage Vsus−Vdata+Vth is applied, as a bias voltage, between the gate terminal and source terminal of the transistor M1. Since the bias voltage includes the threshold voltage Vth and the source voltage of the transistor M1 is VDD, an influence of the threshold voltage Vth and the source current of the transistor M1 is removed from the source current of the transistor M1. Therefore, the current having the magnitude depending only on the difference between the reference voltage Vsus and the data voltage Vdata can be provided to the organic EL element OLED.

### CITATION LIST

### Patent Literature

### [PTL 1]

Japanese Unexamined Patent Application Publication No. 2005-258407

### SUMMARY OF INVENTION

### Technical Problem

However, according to the conventional pixel circuit and the control method thereof disclosed in PTL1, in the case where the power source voltage VDD fluctuates after time when the source voltage of the above described transistor M1 is held in the capacitor Cvth (for example, when the display image fluctuates in a moving picture display), there is a problem that the current amount provided by the transistor M1 to the organic EL element OLED, that is, the light-emitting luminance of the organic EL element has a error corresponding to the fluctuation amount.

A voltage drop of the power source voltage VDD to be provided to a pixel circuit inevitably occurs according to the current amount consumed in an adjacent pixel circuit (presence or absence of light emission, the magnitude of luminance, and the like) in the display unit having a plurality of pixel circuits arranged. Since the magnitude is changing every second, it is difficult to predict the magnitude.

With reference to (a) to (c) in FIG. 31, a mechanism in which the above described error is generated will be described. For the convenience of description, the power source voltage VDD is a voltage which generates a voltage drop by ΔV1 or ΔV2 from the original power source voltage VDD0.

(a) in FIG. 31 is a circuit diagram which explains a Vth detection operation, that is, an operation of holding, in the capacitor Cvth, a voltage which is dropped from the source voltage of the transistor M1 (here, power source voltage VDD) to the threshold voltage Vth of the transistor M1. The transistors M3 and M5 which are in a non-conducting state in this operation are illustrated in a dotted line. When the power source voltage at this time is VDD0−ΔV1, a voltage difference between the voltage VDD0−ΔV1−Vth and the reference voltage Vsus is held in the capacitor Cvth.

(b) in FIG. 31 is a circuit diagram which explains a data write operation, that is, an operation of obtaining the data voltage Vdata via the transistor M3 and holding the data voltage Vdata in the capacitor Cst. The transistors M2, M4, and M5 which are in a non-conducting state in this operation are illustrated in a dotted line. When the power source voltage at this time is VDD0−ΔV2, a voltage difference between the data voltage Vdata and the power source voltage VDD0−ΔV2 is held in the capacito Cst.

As a result, the bias voltage obtained by adding the voltage held in each of the capacitors Cvth and Cst is (Vsus−(VDD0−ΔV1 Vth))+((VDD0−ΔV2)−Vdata)=(ΔV1−ΔV2)+Vsus−Vdata+Vth. This means that the fluctuation amount difference of the power source voltage (ΔV1−ΔV2) remains in the bias voltage.

(c) in FIG. 31 is a circuit diagram which explains a light-emitting operation, that is, an operation of applying the bias voltage held in the capacitors Cvth and Cst between the gate and the source of the transistor M1, and providing a current from the transistor M1 to the organic EL element OLED. The transistors M2, M3, and M4 which are in a non-conducting state in this operation are illustrated in a dotted line. Current Id provided from the transistor M1 to the organic EL element OLED is β/2×(Vsg−Vth)²=β/2×(ΔV1−ΔV2+Vsus−Vdata)². An error corresponding to the fluctuation amount difference (ΔV1−ΔV2) compared with the precise current amount corresponding to the data voltage Vdata is generated. Here, β=μ×Cox×(W/L), p denotes mobility of the transistor, Cox denotes the capacitance of a gate insulating film of the transistor per unit area, W denotes a channel length of the transistor, and L denotes a channel length of the transistor.

Therefore, in a scene when an image having high contrast in displaying the moving picture is moving at a fast speed in the display area, the fluctuation amount difference (ΔV1−ΔV2) is larger between a voltage drop amount ΔV1 of the power source voltage VDD at the time when the Vth detection operation is completed and a voltage drop amount ΔV2 of the power source voltage VDD at the time when the data write operation is performed, the pixel current cannot be precisely controlled with only the data voltage Vdata. Therefore, it is not possible to emit light corresponding to the data voltage of the organic EL element OLED, and then the display image quality is degraded.

The present invention is conceived in view of the aforementioned problem and has as an object to provide a display device having a pixel circuit which makes it possible to cause the organic EL element to emit light at a precise luminance corresponding to the data voltage, without an influence of change in power source voltage, and a control method thereof.

### Solution to Problem

In order to achieve the aforementioned object, a display device according to an aspect of the present invention is a display device comprising a display unit including pixel circuits, each of the pixel circuits including: a drive transistor; a first capacitive element having a first terminal connected to a source terminal of the drive transistor; a first switching element which switches between conduction and non-conduction between a gate terminal of the drive transistor and a data line transmitting a data voltage corresponding to luminance; a second switching element which switches between conduction and non-conduction between the gate terminal of the drive transistor and a second terminal of the first capacitive element; a third switching element which switches between conduction and non-conduction between the second terminal of the first capacitive element and a reference voltage line transmitting a constant reference voltage; a fourth switching element which switches between conduction and non-conduction between a first power source line transmitting a first power source voltage and the source terminal of the drive transistor; and a light-emitting element having a first terminal connected to a drain terminal of the drive transistor and a second terminal connected to a second power source line transmitting a second power source voltage.

Moreover, a control method according to an aspect of the present invention is a control method of the display device, wherein each of the pixel circuits detects a threshold voltage of the drive transistor, by placing the fourth switching element in a non-conducting state and by placing the third switching element in a conducting state.

### Advantageous Effects of Invention

According to the display device and the control method thereof according to the present invention, since the threshold voltage of the drive transistor is detected by electrically separating the source terminal of the drive transistor from the power source voltage and by connecting the gate terminal of the drive transistor to a predetermined voltage, the detected threshold voltage does not include the influence of the change of the power source voltage.

Therefore, since a current can be provided from the drive transistor to the light-emitting element by applying the bias voltage corrected with the detected threshold voltage and corresponding to the data voltage between the gate terminal and the source terminal of the drive transistor, it is possible to cause the light-emitting element at a precise luminance corresponding to the data voltage, without the influence of the change of the power source voltage.

### BRIEF DESCRIPTION OF DRAWINGS

FIG. 1 is a functional block diagram illustrating an example of a configuration of a display device according to Embodiment 1.

FIG. 2 is a circuit diagram illustrating an example of connecting a pixel circuit, a scanning line drive circuit, and a signal line drive circuit according to Embodiment 1.

FIG. 3 is a circuit diagram illustrating an example of a configuration of a pixel circuit according to Embodiment 1.

FIG. 4 is a timing chart illustrating an example of a control signal and a data signal according to Embodiment 1.

FIG. 5 is a circuit diagram illustrating an example of a configuration of a pixel circuit according to Embodiment 1.

FIG. 6 is a timing chart illustrating an example of a control signal and a data signal according to Embodiment 1.

FIG. 7 is a circuit diagram illustrating an example of an operation of a pixel circuit according to Embodiment 1.

FIG. 8 is a circuit diagram illustrating an example of a configuration of a pixel circuit according to Embodiment 2.

FIG. 9 is a timing chart illustrating an example of a control signal and a data signal according to Embodiment 2.

FIG. 10 is a circuit diagram illustrating an example of a configuration of a pixel circuit according to Embodiment 2.

FIG. 11 is a timing chart illustrating an example of a control signal and a data signal according to Embodiment 2.

FIG. 12 is a circuit diagram illustrating an example of an operation of a pixel circuit according to Embodiment 2.

FIG. 13 is a timing chart illustrating an example of a control signal and a data signal according to Modification of Embodiment 2.

FIG. 14 is a circuit diagram illustrating an example of an operation of a pixel circuit according to Modification of Embodiment 2.

FIG. 15 is a circuit diagram illustrating an example of a configuration of a pixel circuit according to Embodiment 3.

FIG. 16 is a timing chart illustrating an example of a control signal and a data signal according to Embodiment 3.

FIG. 17 is a circuit diagram illustrating an example of a configuration of a pixel circuit according to Embodiment 3.

FIG. 18 is a timing chart illustrating an example of a control signal and a data signal according to Embodiment 3.

FIG. 19 is a timing chart illustrating an example of a control signal and a data signal according to Modification of Embodiment 3.

FIG. 20 is a timing chart illustrating an example of a control signal and a data signal according to Modification of Embodiment 3.

FIG. 21 is a circuit diagram illustrating an example of a configuration of a pixel circuit according to Embodiment 4.

FIG. 22 is a timing chart illustrating an example of a control signal and a data signal according to Embodiment 4.

FIG. 23 is a circuit diagram illustrating an example of a configuration of a pixel circuit according to Embodiment 4.

FIG. 24 is a timing chart illustrating an example of a control signal and a data signal according to Embodiment 4.

FIG. 25 is a circuit diagram illustrating an example of a configuration of a pixel circuit according to Embodiment 5.

FIG. 26 is a timing chart illustrating an example of a control signal and a data signal according to Embodiment 5.

FIG. 27 is a circuit diagram illustrating an example of a configuration of a pixel circuit according to Embodiment 5.

FIG. 28 is a timing chart illustrating an example of a control signal and a data signal according to Embodiment 5.

FIG. 29 is an external view of a thin flat-screen television including the display device according to the present invention.

FIG. 30 is a circuit diagram illustrating an example of a configuration of a conventional pixel circuit.

FIG. 31 is a diagram which explains a mechanism in which an error of light-emitting luminance is generated in a conventional pixel circuit.

### DESCRIPTION OF EMBODIMENTS

In order to achieve the aforementioned object, a display device according to an aspect of the present invention is a display device comprising a display unit including pixel circuits, each of the pixel circuits including: a drive transistor; a first capacitive element having a first terminal connected to a source terminal of the drive transistor; a first switching element which switches between conduction and non-conduction between a gate terminal of the drive transistor and a data line transmitting a data voltage corresponding to luminance; a second switching element which switches between conduction and non-conduction between the gate terminal of the drive transistor and a second terminal of the first capacitive element; a third switching element which switches between conduction and non-conduction between the second terminal of the first capacitive element and a reference voltage line transmitting a constant reference voltage; a fourth switching element which switches between conduction and non-conduction between a first power source line transmitting a first power source voltage and the source terminal of the drive transistor; and a light-emitting element having a first terminal connected to a drain terminal of the drive transistor and a second terminal connected to a second power source line transmitting a second power source voltage.

A display device according to an aspect of the present invention is a display device comprising a display unit including pixel circuits, each of the pixel circuits including: a drive transistor having a drain terminal connected to a first power source line transmitting a first power source voltage; a first capacitive element having a first terminal connected to a source terminal of the drive transistor; a first switching element which switches between conduction and non-conduction between a gate terminal of the drive transistor and a data line transmitting a data voltage corresponding to luminance; a second switching element which switches between conduction and non-conduction between the gate terminal of the drive transistor and a second terminal of the first capacitive element; a third switching element which switches between conduction and non-conduction between the second terminal of the first capacitive element and a reference voltage line transmitting a constant reference voltage; a light-emitting element having a first terminal connected to a second power source line transmitting a second power source voltage; and a fourth switching element which switches between conduction and non-conduction between the source terminal of the drive transistor and a second terminal of the light-emitting element.

Moreover, it is possible that each of the pixel circuits detects a threshold voltage of the drive transistor, by placing the fourth switching element in a non-conducting state and by placing the third switching element in a conducting state.

With these configurations, since the threshold voltage of the drive transistor is detected by electrically separating the source terminal of the drive transistor from the power source voltage and by connecting the gate terminal of the drive transistor to a predetermined voltage, the detected threshold voltage does not include the influence of the change in the power source voltage.

Therefore, since a current can be provided from the drive transistor to the light-emitting element by applying the bias voltage corrected with the detected threshold voltage and corresponding to the data voltage between the gate terminal and the source terminal of the drive transistor, it is possible to cause the light-emitting element at a precise luminance corresponding to the data voltage, without the influence of the change of the power source voltage.

Moreover, it is possible that each of the pixel circuits further includes a second capacitive element having a first terminal connected to the gate terminal of the drive circuit and having a second terminal connected to the second terminal of the first capacitive element.

With this configuration, it is possible to detect the threshold voltage by applying the data voltage held in the second capacitive element to the gate terminal of the drive transistor. Therefore, after the data voltage is obtained from the data line to the second capacitive element, it is possible to detect the threshold voltage at a higher precision by taking sufficient time.

Moreover, a capacitance value of the second capacitive element can be smaller than the capacitance value of the first capacitive element. Moreover, it is possible that in each of the pixel circuits, each of the first switching element and the third switching element is a double-gate thin-film transistor, and the second switching element is a double-gate thin-film transistor.

With this configuration, since the leakage of the first capacitive element can be decreased, it is possible to cause the light-emitting element to emit light at a more precise luminance.

A control method according to an aspect of the present invention is a control method of a display device, the display device comprising a display unit including pixel circuits, each of the pixel circuits including: a drive transistor; a first capacitive element having a first terminal connected to a source terminal of the drive transistor; a first switching element which switches between conduction and non-conduction between a gate terminal of the drive transistor and a data line transmitting a data voltage corresponding to luminance; a second switching element which switches between conduction and non-conduction between the gate terminal of the drive transistor and a second terminal of the first capacitive element; a third switching element which switches between conduction and non-conduction between the second terminal of the first capacitive element and a reference voltage line transmitting a constant reference voltage; a fourth switching element which switches between conduction and non-conduction between a first power source line transmitting a first power source voltage and the source terminal of the drive transistor; and a light-emitting element having a first terminal connected to a drain terminal of the drive transistor, and having a second terminal connected to a second power source line transmitting a second power source voltage, the control method comprising detecting a threshold voltage of the drive transistor by placing the fourth switching element in a non-conducting state and by placing the third switching element in a conducting state, in each of the pixel circuits.

A control method according to an aspect of the present invention is a control method of a display device, the display circuit comprising a display unit including pixel circuits, each of the pixel circuits including: a drive transistor having a drain terminal connected to a first power source line transmitting a first power source voltage; a first capacitive element having a first terminal connected to a source terminal of the drive transistor; a first switching element which switches between conduction and non-conduction between a gate terminal of the drive transistor and a data line transmitting a data voltage corresponding to luminance; a second switching element which switches between conduction and non-conduction between the gate terminal of the drive transistor and a second terminal of the first capacitive element; a third switching element which switches between conduction and non-conduction between the second terminal of the first capacitive element and a reference voltage line transmitting a constant reference voltage; a light-emitting element having a first terminal connected to a second power source line transmitting a second power source voltage; and a fourth switching element which switches between conduction and non-conduction between the source terminal of the drive transistor and a second terminal of the light-emitting element, the control method comprising detecting a threshold voltage of the drive transistor, by placing the fourth switching element in a non-conducting state and by placing the third switching element in a conducting state, in each of the pixel circuits.

It is possible that the control method comprises writing, in each of the pixel circuits, a data voltage from the data line, by placing the second switching element and the fourth element in a non-conducting state and by placing the first switching element in a conducting state; and providing, in each of the pixel circuits, a current from the drive transistor to the light-emitting element, by placing the fourth switching element in a conducting state, and by applying a bias voltage corresponding to the data voltage Vdata and corrected by the threshold voltage Vth, between the gate terminal and the source terminal of the drive transistor.

With these configurations, since the threshold voltage of the drive transistor is detected by electrically separating the source terminal of the drive transistor from the power source voltage and by connecting the gate terminal of the drive transistor to a predetermined voltage, the detected threshold voltage does not include the influence of the change of the power source voltage.

Furthermore, since a current can be provided from the drive transistor to the light-emitting element by applying the bias voltage corrected with the detected threshold voltage and corresponding to the data voltage between the gate terminal and the source terminal of the drive transistor, it is possible to cause the light-emitting element to emit light at a precise luminance corresponding to the data voltage without the influence of the change of the power source voltage.

The following will describe embodiments in the present invention. It should be noted that, in all the figures, the same reference signs are given to components that fulfill the same functions and redundant description thereof shall be omitted.

### Embodiment 1

Embodiment 1 according to the present invention will be described with reference to the Drawings.

A display device according to Embodiment 1 is a display device which includes a display unit in which a plurality of pixel circuits are arranged in a matrix. Each of the pixel circuits is configured so that a precise bias voltage corresponding to the light-emitting luminance is held in a capacitor regardless of the change of the power source voltage.

The following will describe Embodiment 1 according to the present invention with reference to the Drawings.

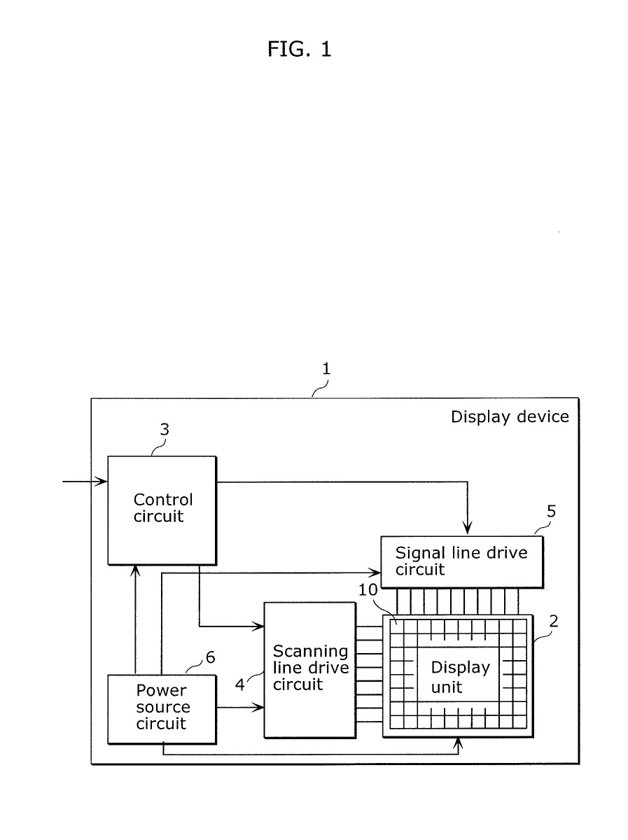

FIG. 1 is a functional block diagram illustrating an example of a configuration of a display device 1 according to Embodiment 1.

The display device 1 includes a display unit 2, a control circuit 3, a scanning line drive circuit 4, a signal line drive circuit 5, and a power source circuit 6.

The display unit 2 includes a plurality of pixel circuits 10 that are arranged in a matrix. Each of rows in the matrix is provided with a scanning signal line, and each of the columns of the matrix is provided with a data signal line.

The control circuit 3 is a circuit that controls the operation of the display device 1, receives a video signal from an external source, and controls the scanning line drive circuit 4 and the signal line drive circuit 5 so that the image represented by the video signal is displayed on the display unit 2.

The scanning line drive circuit 4 provides a control signal for controlling the operation of the pixel circuit 10, to the pixel circuit 10 via the scanning signal line provided with each of the rows in the display unit 2.

The signal line drive circuit 5 provides a data signal which is a voltage signal corresponding to light-emitting luminance, to the pixel circuit 10, via the data signal line provided in each of the columns of the display unit 2.

The power source circuit 6 provides the power source for the operation of the display device 1, to the respective parts of the display device 1.

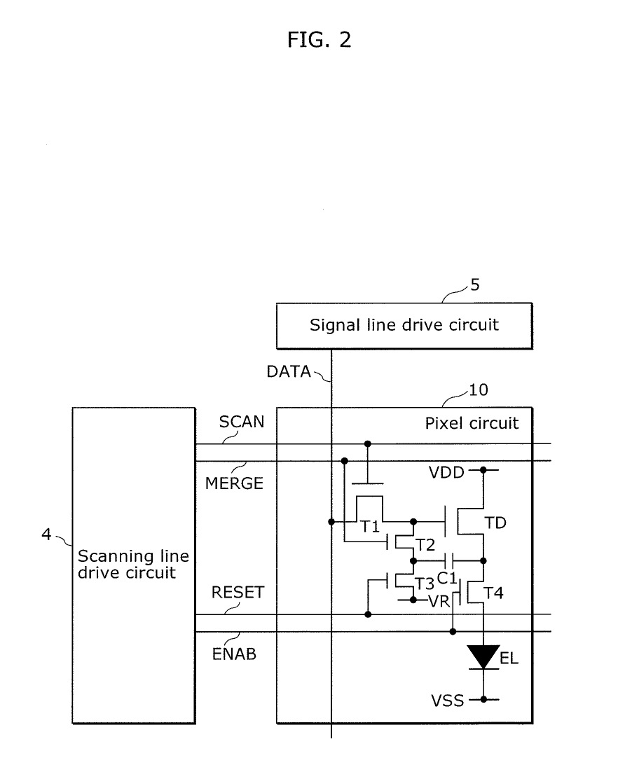

FIG. 2 is a circuit diagram showing an example of the connections between the pixel circuit 10, the scanning line drive circuit 4, and the signal line drive circuit 5.

Signal lines SCAN, MERGE, RESET, and ENAB are provided, as a scanning signal line which is commonly connected to the pixel circuits 10 arranged in the same row, in each of the rows of the display unit 2. A signal line DATA is provided, as a data signal line which is commonly connected to the pixel circuits 10 arranged in the same column, in each of the columns of the display unit 2.

Furthermore, the display unit 2 is provided with a power source line VDD for transmitting and distributing, to the pixel circuit 10, the positive power source voltage provided from a power source circuit 6, a power source line VSS for transmitting and distributing, to the pixel circuit 10, the negative power source voltage provided from a power source circuit 6, and a reference voltage line VR for transmitting and distributing, to the pixel circuit 10, a constant reference voltage provided from the power course circuit 6. The power source lines VDD and VSS, and the reference voltage line VR are commonly connected to all the pixel circuits 10.

Although a complex voltage fluctuation due to a voltage drop caused by electric resistance occurs at a connection point between the pixel circuit 10 and each of the power source lines VDD and VSS providing a current to the organic EL element EL, a routine voltage drop does not occur at the reference voltage line VR which does not provide a DC current.

Each of the pixel circuits 10 that are arranged in the display unit 2 is connected to the scanning line drive circuit 4 by the signal lines SCAN, MERGE, RESET, and ENAB of the row in which the pixel circuit 10 is located, and connected to the signal line drive circuit 5 by the signal line DATA of the column in which the pixel circuit 10 is located.

The signal lines SCAN, MERGE, RESET, and ENAB transmit a control signal for controlling the operation of the pixel circuit 10, from the scanning line drive circuit 4 to the pixel circuit 10. The signal line DATA transmits a data signal corresponding to the light-emitting luminance, from the signal line drive circuit 5 to the pixel circuit 10.

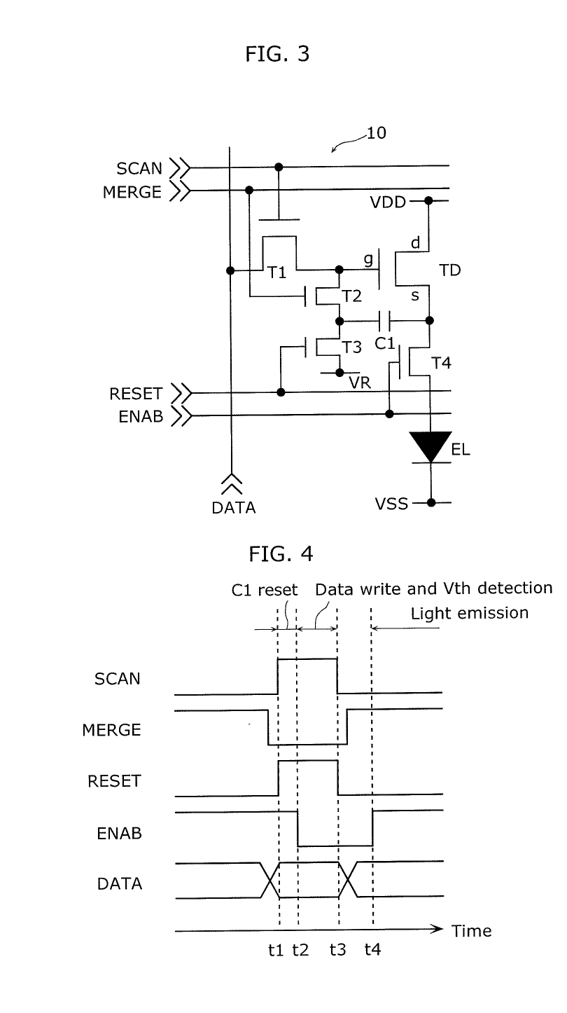

FIG. 3 is a circuit diagram illustrating an example of a configuration of the pixel circuit 10.

The pixel circuit 10 is a circuit that causes the organic EL element to emit light at a luminance corresponding to the data signal, and includes the drive transistor TD, the switching transistors T1 to T4, the capacitor C1, and the organic EL element EL. Each of the drive transistor TD and the switching transistors T1 to T4 is configured of an n-type thin-film transistor (TFT).

The driving transistor TD has a drain terminal d which is connected to the power source line VDD.

The capacitor C1 has a first terminal (at the right side of the illustration) which is connected to the source terminal s of the drive transistor TD, and a second terminal (at the left side of the illustration) which is connected to the gate terminal g of the drive transistor TD via the switching transistor T2.

The organic EL element EL has a first terminal (at the bottom side of the illustration) which is connected to the power source line VSS.

The switching transistor T1 switches between conduction and non-conduction between the gate terminal g of the driving transistor TD and the data line DATA, according to the control signal transmitted by the signal line SCAN.

The switching transistor T2 switches between conduction and non-conduction between the gate terminal g of the driving transistor TD and the second terminal of the capacitor C1, according to the control signal transmitted by the signal line MERGE.

The switching transistor T3 switches between conduction and non-conduction between the second terminal of the capacitor C1 and the reference voltage line VR, according to the control signal transmitted by the signal line RESET.

The switching transistor T4 switches between conduction and non-conduction between the source terminal s of the driving transistor TD and the second terminal (at the top side of the illustration) of the organic EL element EL, according to the control signal transmitted by the signal line ENAB.

Here, the switching transistors T1 to T4 are the respective examples of the first to fourth switching elements, the capacitor C1 is an example of the first capacitive element, and the organic EL element EL is an example of a light-emitting element. Moreover, the power source line VDD is an example of the first power source line, and the power source line VSS is an example of the second power source line. Moreover, the data signal is an example of the data voltage.

FIG. 4 is a timing chart illustrating an example of the control signal, power source voltage, and data signal for operating the pixel circuit 10, for one frame period. In FIG. 4, the vertical axis denotes the level of each signal, and the horizontal axis represents the passing of time. Since each of the switching transistors T1 to T4 of the pixel circuit 10 is configured of an n-type transistor, each of the switching transistors T1 to T4 is in a conducting state in a period in which the corresponding control signal is at the HIGH level, and is in a non-conducting state in a period in which the corresponding control signal is at the LOW level.

The operation of the pixel circuit 10 performed according to the control signal and the data signal illustrated in FIG. 4 will be described. For the convenience of explanation, the voltage at the connection point between each of the power source lines VDD and VSS and the pixel circuit 10 is described as the positive power source voltage VDD and the negative power source voltage VSS, and the voltage of the reference voltage line VR is described as the reference voltage VR.

A C1 reset operation is performed in a C1 reset period from time t1 to time t2. The C1 reset operation is an operation which resets the voltage of the capacitor C1 to a predetermined voltage.

In the C1 reset period, the switching transistors T1, T3, and T4 are in a conducting state, the gate terminal g of the drive transistor TD is set to the voltage of the data line DATA, the second terminal of the capacitor C1 is set to the reference voltage VR, and the source terminal s of the drive transistor TD which is the voltage of the first terminal of the capacitor C1 is set to the voltage obtained by adding an ON voltage of the organic EL element EL corresponding to the voltage of the gate terminal g of the driving transistor TD to the negative power source voltage VSS. With this, since the voltage of the capacitor C1 is initialized in every frame, the influence of the voltage in the preceding frame which remains in the capacitor C1 when the preceding frame ends is removed.

In the data write and Vth detection period from time t2 to time t3, the data write operation and the Vth detection operation are performed in parallel. The data write operation is an operation in which, from the signal line DATA via the switching transistor T1, the data voltage Vdata is transmitted to the pixel (that is, the data voltage Vdata is written in the pixel circuit 10). The Vth detection operation is an operation in which the threshold voltage Vth of the drive transistor TD is detected by applying a predetermined voltage to the gate terminal g of the drive transistor TD, and the data voltage Vdata is used as the predetermined voltage.

In the data write and Vth detection period, the switching transistor T4 is in a non-conducting state, and the source terminal s of the drive transistor TD is electrically separated from the negative power source voltage VSS. Moreover, the switching transistor T1 is in a conducting state, the data voltage Vdata is obtained from the signal line DATA, and the data voltage Vdata is applied to the gate terminal g of the drive transistor TD. Moreover, the positive power source voltage VDD is set to a voltage higher than the voltage obtained by adding, to the highest voltage of the signal line DATA, the largest value of the threshold voltage Vth in the drive transistor TD of all the pixels.

As a result, since, in the data write and Vth detection period, the drive transistor TD inevitably operates in a saturated region, the drain-source current of the drive transistor TD is controlled only by the voltage between the drain and source terminals. Since the gate terminal g of the drive transistor TD is currently fixed to the data voltage Vdata, the drain-source current of the drive transistor TD is controlled by the voltage of the source terminal s.

Since the switching transistor T4 is in a non-conducting state, only the first terminal of the capacitor C1 is connected to the source terminal of the drive transistor TD. The drain-source current of the drive transistor flows through the capacitor C1. Accordingly, the capacitor C1 is charged, the voltage of the first terminal of the capacitor C1, that is, the voltage of the source terminal s of the drive transistor TD increases to finally reach Vdata−Vth. That is, when the voltage between the gate and source terminals of the drive transistor is equal to the threshold voltage Vth of the drive transistor TD, the drive transistor TD is in an OFF state.

As described above, the voltage of the source terminal s of the drive transistor TD is converged to the voltage Vdata−Vth which is dropped from the data voltage Vdata to the threshold voltage Vth, without the influence of the positive power source voltage VDD and the negative power source voltage VSS.

A voltage difference between this voltage and the reference voltage VR is held in the capacitor C1. The voltage held in the capacitor C1 is VR−(Vdata−Vth), and this voltage does not include the influence of the positive power source voltage VDD and the negative power source voltage VSS.

A light-emitting operation is performed in a light-emitting period after time t4. The light-emitting operation is an operation in which the bias voltage corresponding to the data voltage Vdata and corrected by the threshold voltage Vth is applied between the gate and source terminals of the drive transistor TD, and then a current is provided from the drive transistor TD to the organic EL element EL.

In the light-emitting period, the switching transistors T1 and T3 are in a non-conducting state and the switching transistor T2 is in a conducting state. Then, the voltage (VR−Vdata−Vth) held in the capacitor C1 is applied between the gate and source terminals of the driving transistor TD.

As a result, the voltage Isd=β/2×(VR−Vdata)² which has the precise magnitude and corresponds to the data voltage Vdata is provided from the drive transistor TD to the organic EL element EL, it is possible to cause the organic EL element EL to emit light at a precise luminance corresponding to the data voltage Vdata, without the influence of the change of the power source voltage.

It should be noted that it is desirable that, in the pixel circuit 10, the switching transistors T1 and T3 are configured of a double-gate TFT. It is more desirable that the switching transistor T2 is also configured of a double-gate TFT. With this configuration, since the leakage of the capacitor C1 can be decreased, it is possible to cause the organic EL element EL to emit light at a more precise luminance.

Moreover, in the pixel circuit 10, the following modification is possible.

For example, since the signal lines SCAN and RESET, as illustrated in FIG. 4, transmit the same control signal, one signal line may serve as both the signal lines SCAN and RESET.

Moreover, the switching transistor T2 may be configured of a p-type transistor. Since the level of the control signal is reversed, the switching transistor T2 configured of the p-type transistor can be controlled by the control signal of the switching transistors T1 and T3 configured of the n-type transistor. In this case, one signal line may serve as all of the signal lines SCAN, MERGE, and RESET.

Moreover, one signal line may serve as both the signal line ENAB and the signal line MERGE in an adjacent row.

Since the use of the signal line for multiple purposes can reduce the footprint of a signal line, the use of the signal line for multiple purposes increases the arrangement density of the pixel circuit 10 and contributes to realizing a high-definition display device. Moreover, since the number of outputs of the scanning line drive circuit 4 can be decreased, the circuit size can be reduced and a cost can be decreased.

Furthermore, the drive transistor TD and the switching transistors T1 to T5 can be all configured of a p-type transistor. The following will describe a pixel circuit having such a configuration.

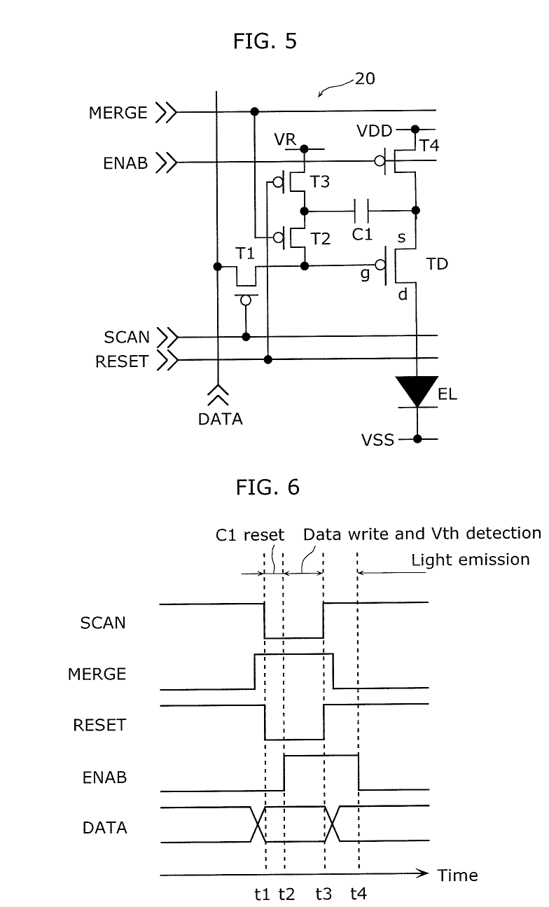

FIG. 5 is a circuit diagram illustrating an example of a configuration of a pixel circuit 20. The pixel circuit 20, as similarly to the pixel circuit 10 illustrated in FIG. 3, is a circuit that causes the organic EL element EL to emit light at luminance corresponding to the data signal, and includes the drive transistor TD, the switching transistors T1 to T4, the capacitor C1, and the organic EL element EL.

Compared with the pixel circuit 10, the pixel circuit 20 is different in that the drive transistor TD and the switching transistors T1 to T5 are all configured of the p-type transistor. The pixel circuit 20 performs the same operation as the pixel circuit 10 when provided with the control signal having the level obtained by simply reversing the level of the control signal used in the pixel circuit 10.

The capacitor C1 has a first terminal (at the right side of the illustration) which is connected to the source terminal s of the drive transistor TD, and a second terminal (at the left side of the illustration) which is connected to the gate terminal g of the drive transistor TD via the switching transistor T2.

The organic EL element EL has a first terminal (at the bottom side of the illustration) which is connected to the drain terminal d of the drive transistor, and a second terminal (at the bottom side of the illustration) which is connected to the power source line VSS.

The switching transistor T1 switches between conduction and non-conduction between the gate terminal g of the driving transistor TD and the data line DATA, according to the control signal transmitted by the signal line SCAN.

The switching transistor T2 switches between conduction and non-conduction between the gate terminal g of the driving transistor TD and the second terminal of the capacitor C1, according to the control signal transmitted by the signal line MERGE.

The switching transistor T3 switches between conduction and non-conduction between the second terminal of the capacitor C1 and the reference voltage line VR, according to the control signal transmitted by the signal line RESET.

The switching transistor T4 switches between conduction and non-conduction between the power source line VDD and the source terminal s of the driving transistor TD, according to the control signal transmitted by the signal line ENAB.

Here, the switching transistors T1 to T4 are the respective examples of the first to fourth switching elements, the capacitor C1 is an example of the first capacitive element, and the organic EL element EL is an example of a light-emitting element. Moreover, the power source line VDD is an example of the first power source line, and the power source line VSS is an example of the second power source line. Moreover, the data signal is an example of the data voltage.

FIG. 6 is a timing chart illustrating an example of the control signal and the data signal for operating the pixel circuit 20, for one frame period. In FIG. 6, the vertical axis denotes the level of each signal, and the horizontal axis represents the passing of time. Since each of the switching transistors T1 to T4 of the pixel circuit 20 is configured of a p-type transistor, each of the switching transistors T1 to T4 is in a conducting state in a period in which the corresponding control signal is at the LOW level, and is in a non-conducting state in a period in which the corresponding control signal is at the HIGH level. The control signal for operating the pixel circuit 20 illustrated in FIG. 6 is a control signal obtained by simply reversing the level of the control signal for operating the pixel circuit 10 illustrated in FIG. 4.

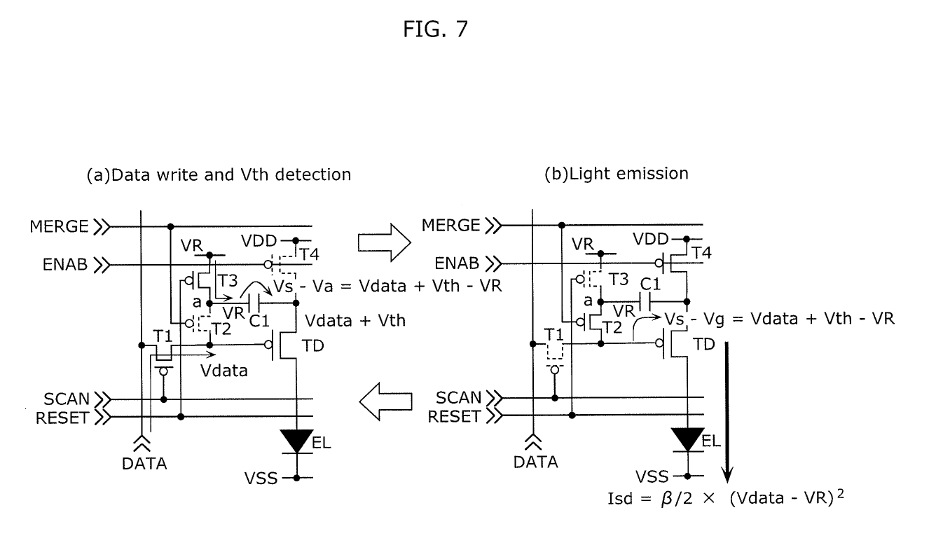

The operation of the pixel circuit 20 performed according to the control signal and the data signal illustrated in FIG. 6 will be described with reference to (a) and (b) in FIG. 7.

A C1 reset operation is performed in a C1 reset period from time t1 to time t2.

In the C1 reset period, the switching transistors T3 and T2 are in a conducting state, the second terminal of the capacitor C1 is set to the reference voltage VR, and the first terminal of the capacitor C1 is set to the positive power source voltage VDD. With this, since the voltage of the capacitor C1 is initialized to the same voltage in every frame, the influence of the voltage in the preceding frame which remains in the capacitor C1 when the preceding frame ends is removed.

In the data write and the Vth detection period from time t2 to time t3, the data write operation and the Vth detection operations are performed in parallel.

(a) in FIG. 7 is a circuit diagram which explains a data write operation and a Vth detection operation. The switching transistors T2 and T4 which are in a non-conducting state in the data write and Vth detection period are illustrated in a dotted line.

In the data write and Vth detection period, the switching transistor T4 is in a non-conducting state, and the source terminal s of the drive transistor TD is electrically separated from the positive power source voltage VDD. Moreover, the switching transistor T1 is in a conducting state, the data voltage Vdata is obtained from the signal line DATA, and the data voltage Vdata is applied to the gate terminal g of the drive transistor TD. Moreover, the negative power source voltage VSS is set to a voltage lower than the voltage obtained by adding, to the lowest voltage of the signal line DATA, the largest value of the threshold voltage Vth in the drive transistor TD of all the pixels, and by subtracting the threshold voltage Vth (EL) of the organic EL element EL.

As a result, since, in the data write and Vth detection period, the drive transistor TD inevitably operates in a saturated region, the source-drain current of the drive transistor TD is controlled only by the voltage between the source and drain terminals. Since the gate terminal g of the drive transistor TD is currently fixed to the data voltage Vdata, the drain current of the drive transistor TD is controlled by the voltage of the source terminal s.

Since the switching transistor T4 is in a non-conducting state, only the first terminal of the capacitor C1 is connected to the source terminal of the drive transistor TD. The source-drain current of the drive transistor flows from the capacitor C1. Accordingly, the capacitor C1 is discharged, the voltage of the first terminal of the capacitor C1, that is, the voltage of the source terminal s of the drive transistor TD drops to finally reach Vdata+Vth. That is, when the voltage between the gate and source terminals of the drive transistor is equal to the threshold voltage Vth of the drive transistor TD, the drive transistor TD is in an OFF state.

As described above, the voltage of the source terminal s of the drive transistor TD is converged to the voltage Vdata+Vth which is increased by the threshold voltage Vth from the data voltage Vdata, without the influence of the positive power source voltage VDD and the negative power source voltage VSS.

A voltage difference between this voltage and the reference voltage VR is held in the capacitor C1. The voltage held in the capacitor C1 is (Vdata+Vth)−VR, and this voltage does not include the influence of the positive power source voltage VDD and the negative power source voltage VSS.

A light-emitting operation is performed in a light-emitting period after time t4.

(b) in FIG. 7 is a circuit diagram which explains the light-emitting operation. The switching transistors T1 and T3 which are in a non-conducting state in the light-emitting period are illustrated in a dotted line.

In the light-emitting period, the switching transistors T1 and T3 are in a non-conducting state, the switching transistor T2 is in a conducting state, and the voltage (Vdata+Vth)−VR held in the capacitor C1 is applied between the gate and source of the drive transistor TD.

As a result, the voltage Isd=β/2×(Vdata−VR)² which has a precise magnitude and corresponds to the data voltage Vdata is provided from the drive transistor TD to the organic EL element EL, it is possible to cause the organic EL element to emit light at a precise luminance corresponding to the data voltage Vdata, without the influence of the change of the power source voltage.

It should be noted that it is desirable that, in the pixel circuit 20, the switching transistors T1 and T3 are configured of a double-gate TFT. It is more desirable that the switching transistor T2 is also configured of a double-gate TFT. With this configuration, since the leakage of the capacitor C1 can be decreased, it is possible to cause the organic EL element EL to emit light at a more precise luminance.

Moreover, in the pixel circuit 20, the following modification is possible. In other words, one signal line may serve as both the signal lines SCAN and RESET. By configuring the switching transistor T2 of an n-type transistor, one signal line may serve as all of the signal lines SCAN, MERGE, and RESET.

Moreover, one signal lien may serve both as the signal line ENAB and the signal line MERGE in an adjacent row.

Since the use of the signal line for multiple purposes can reduce the footprint of a signal line, the use of the signal line for multiple purposes increases the arrangement density of the pixel circuit 20 and contributes to realizing a high-definition display device. Moreover, since the number of outputs of the scanning line drive circuit 4 can be decreased, the circuit size can be reduced and a cost can be decreased.

### Embodiment 2

Embodiment 2 according to the present invention will be described with reference to the Drawings.

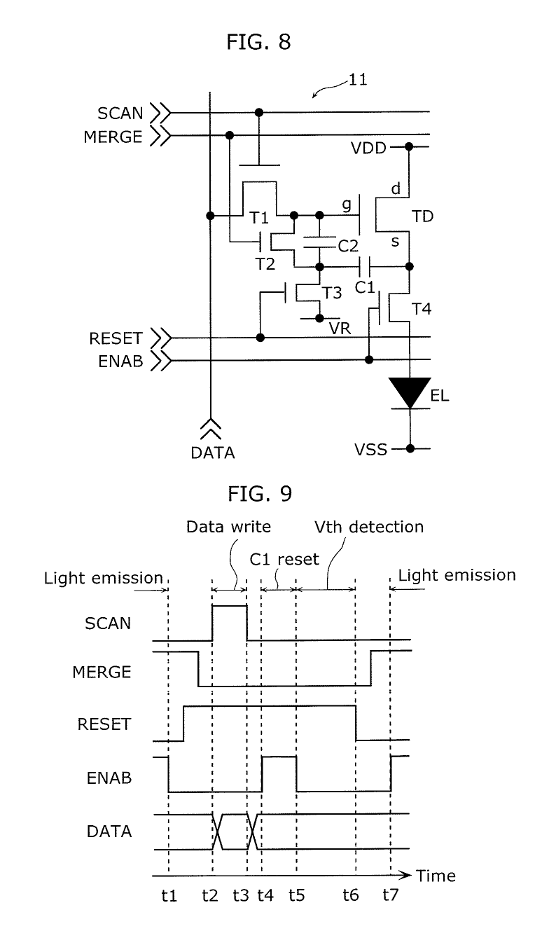

FIG. 8 is a circuit diagram illustrating an example of a configuration of a pixel circuit 11 according to Embodiment 2. The pixel circuit 11 is configured by adding, to the pixel circuit 10 in FIG. 3, the capacitor C2 for holding the data voltage Vdata. The capacitor C2 is connected in parallel to the switching transistor T2. The capacitor C2 is an example of the second capacitive element.

FIG. 9 is a timing chart illustrating an example of the control signal and the data signal for operating the pixel circuit 11, for one frame period. In FIG. 9, the vertical axis denotes the level of each signal, and the horizontal axis represents the passing of time.

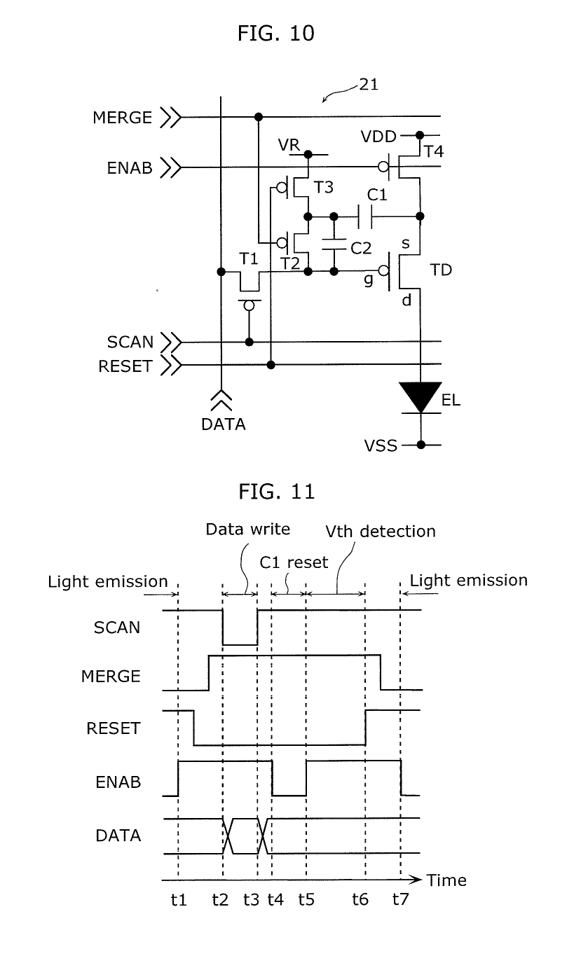

FIG. 10 is a circuit diagram illustrating an example of a configuration of a pixel circuit 21 according to Embodiment 2. The pixel circuit 21 is configured by adding, to the pixel circuit 20 in FIG. 5, the capacitor C2 for holding the data voltage Vdata. The capacitor C2 is connected in parallel to the switching transistor T2. The capacitor C2 is an example of the second capacitive element.

FIG. 11 is a timing chart illustrating an example of the control signal and the data signal for operating the pixel circuit 11, for one frame period. In FIG. 11, the vertical axis denotes the level of each signal, and the horizontal axis represents the passing of time.

The drive transistor TD, and the switching transistors T1 to T4 are configured of an n-type transistor in the pixel circuit 11, and configured of a p-type transistor in the pixel circuit 21. The pixel circuit 11 and the pixel circuit 21, illustrated in FIG. 9 and FIG. 11, respectively, perform the same operation when provided with control signals having respective levels obtained by simply reversing the levels of the control signals.

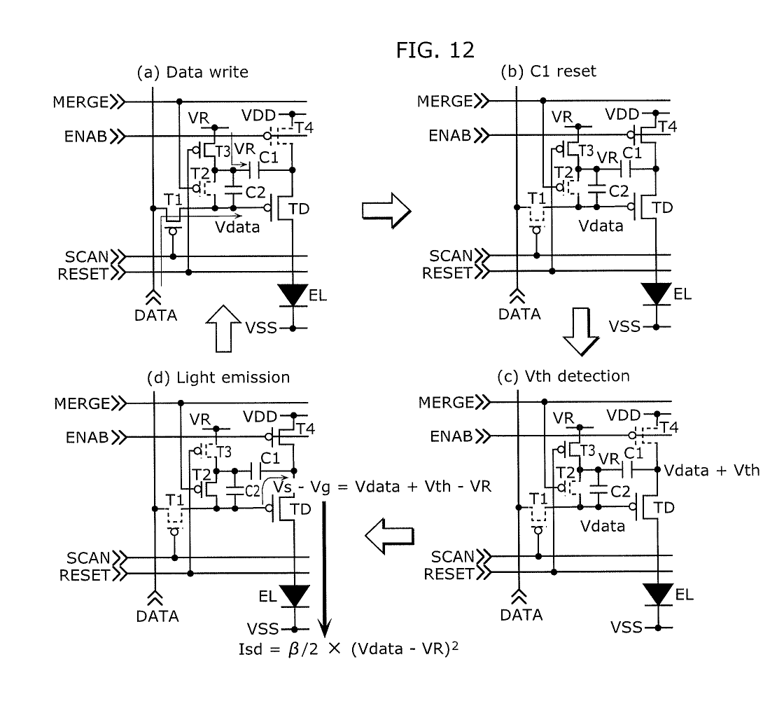

The operation of the pixel circuit 21 performed according to the control signal and the data signal illustrated in FIG. 11 will be described with reference to (a) and (d) in FIG. 12.

The light emission in the preceding frame ends at time t1.

A data write operation is performed in a data write period from time t2 to time t3.

(a) in FIG. 12 is a circuit diagram which explains the data write operation. The switching transistors T2 and T4 which are in a non-conducting state in the data write period are illustrated in a dotted line.

In the data write period, the switching transistors T1 and T3 are in a conducting state, the data voltage Vdata is obtained from the signal line DATA, and a voltage difference between the data voltage Vdata and the reference voltage VR is held in the capacitor C2.

A C1 reset operation is performed in a C1 reset period from time t4 to time t5.

(b) in FIG. 12 is a circuit diagram which explains the C1 reset operation. The switching transistors T1 and T2 which are in a non-conducting state in the C1 reset period are illustrated in a dotted line.

In the C1 reset period, the switching transistors T3 and T4 are in a conducting state, the second terminal of the capacitor C1 is set to the reference voltage VR, and the first terminal of the capacitor C1 is set to the positive power source voltage VDD. With this, since the voltage of the capacitor C1 is initialized to the same voltage in every frame, the influence of the voltage in the preceding frame which remains in the capacitor C1 when the preceding frame ends is removed.

The Vth detection operation is performed in the Vth detection period from time t5 to time t6.

(c) in FIG. 12 is a circuit diagram which explains the Vth detection operation. The switching transistors T1, T2, and T4 which are in a non-conducting state in the Vth detection period are illustrated in a dotted line.

In the Vth detection period, the switching transistor T4 is in a non-conducting state, and the source terminal s of the drive transistor TD is electrically separated from the positive power source voltage VDD. The data voltage Vdata held in the capacitor C2 is applied to the gate terminal g of the drive transistor TD. As a result, by the same operation as that in (a) in FIG. 7, the voltage of the source terminal s of the drive transistor TD is converged to the voltage Vdata+Vth which is increased by the threshold voltage Vth from the data voltage Vdata, without the influence of the positive power source voltage VDD and the negative power source voltage VSS.

A voltage difference between this voltage and the reference voltage VR is held in the capacitor C1. The voltage held in the capacitor C1 is (Vdata+Vth)−VR, and this voltage does not include the influence of the positive power source voltage VDD and the negative power source voltage VSS.

A light-emitting operation is performed in a light-emitting period after time t7.

(d) in FIG. 7 is a circuit diagram which explains the light-emitting operation. The switching transistors T1 and T3 which are in a non-conducting state in the light-emitting period are illustrated in a dotted line.

In the light-emitting period, the switching transistors T1 and T3 are in a non-conducting state, and the switching transistor T2 is in a conducting state. Then, the voltage (Vdata+Vth)−VR held in the capacitor C1 is applied between the gate and source terminals of the driving transistor TD.

As a result, the voltage Isd=β/2×(Vdata−VR)² which has a precise magnitude and corresponds to the data voltage Vdata is provided from the drive transistor TD to the organic EL element EL, it is possible to cause the organic EL element EL to emit light at a precise luminance corresponding to the data voltage Vdata, without the influence of the change of the power source voltage.

It should be noted that it is desirable that, in the pixel circuits 11 and 21, the switching transistors T1 and T3 are configured of a double-gate TFT. It is more desirable that the switching transistor T2 is also configured of a double-gate TFT. With this configuration, since the leakage of the capacitor C1 can be decreased, it is possible to cause the organic EL element EL to emit light at a more precise luminance.

Moreover, in the pixel circuits 11 and 21, the following modifications are possible.

For example, by configuring the drive transistor T2 of the pixel circuit 11 of a p-type transistor, one signal line may serve as both the signal lines SCAN and RESET. By configuring the switching transistor T2 of an n-type transistor, one signal line may serve as all of the signal lines SCAN, MERGE, and RESET.

Since the use of the signal line for multiple purposes can reduce the footprint of a signal line, the use of the signal line for multiple purposes increases the arrangement density of each of the pixel circuits 11 and 21 and contributes to realizing a high-definition display device. Moreover, since the number of outputs of the scanning line drive circuit 4 can be decreased, the circuit size can be reduced and a cost can be decreased.

### Modification of Embodiment 2

Modification of Embodiment 2 according to the present invention will be described with reference to the Drawings. The present modification illustrates another example of an operation of the pixel circuit 11 illustrated in FIG. 8.

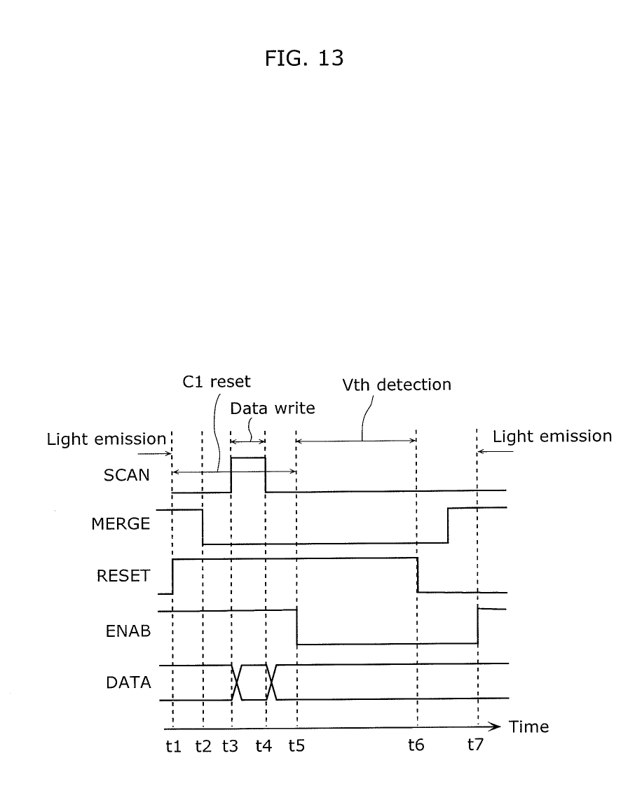

FIG. 13 is a timing chart illustrating an example of the control signal and the data signal for operating the pixel circuit 11, for one frame period. In FIG. 13, the vertical axis denotes the level of each signal, and the horizontal axis represents the passing of time.

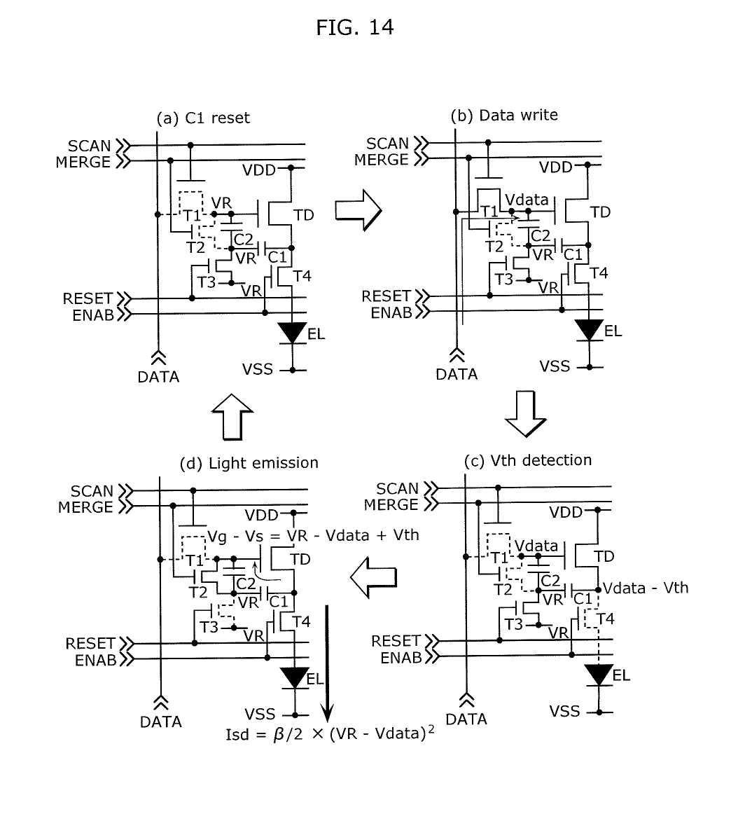

The operation of the pixel circuit 11 performed according to the control signal and the data signal illustrated in FIG. 13 will be described with reference to (a) and (d) in FIG. 14.

The light emission in the preceding frame ends at time t1.

A C1 reset operation is performed in a C1 reset period from time t1 to time t5.

(a) in FIG. 14 is a circuit diagram which explains the C1 reset operation. The switching transistors T1 and T2 which are in a non-conducting state in the C1 reset period are illustrated in a dotted line.

In the C1 reset period, the switching transistors T3 and T4 are in a conducting state, the second terminal of the capacitor C1 is set to the reference voltage VR, and the first terminal of the capacitor C1 is set to a voltage obtained by adding the voltage of the organic EL element EL corresponding to the voltage of the gate terminal g of the drive transistor TD to the negative power source voltage VSS, as the source voltage of the drive transistor TD which is the voltage of the first terminal of the capacitor C1. With this, since the voltage of the capacitor C1 is initialized to the same voltage in every frame, the influence of the voltage in the preceding frame which remains in the capacitor C1 when the preceding frame ends is removed.

A data write operation is performed in a data write period from time t3 to time t4.

(b) in FIG. 14 is a circuit diagram which explains the data write operation. The switching transistor T2 which is in a non-conducting state in the data write period is illustrated in a dotted line.

In the data write period, the switching transistors T1 and T3 are in a conducting state, the data voltage Vdata is obtained from the signal line DATA, and a voltage difference between the data voltage Vdata and the reference voltage VR is held in the capacitor C2.

The Vth detection operation is performed in the Vth detection period from time t5 to time t6.

(c) in FIG. 14 is a circuit diagram which explains the Vth detection operation. The switching transistors T1, T2, and T4 which are in a non-conducting state in the Vth detection period are illustrated in a dotted line.

In the Vth detection period, the switching transistor T4 is in a non-conducting state, and the source terminal s of the drive transistor TD is electrically separated from the negative power source voltage VSS. The data voltage Vdata held in the capacitor C2 is applied to the gate terminal g of the drive transistor TD. Moreover, the positive power source voltage VDD is set to a voltage higher than the voltage obtained by adding, to the highest voltage of the signal line DATA, the largest value of the threshold voltage Vth in the drive transistor TD of all the pixels.

As a result, since, in the data write and Vth detection period, the drive transistor TD inevitably operates in a saturated region, the drain-source current of the drive transistor TD is controlled by the voltage between the drain and source terminals. Since the gate terminal of the drive transistor TD is currently fixed to the data voltage Vdata, the drain-source current of the drive transistor TD is controlled by the voltage of the source terminal s.

Only the first terminal of the capacitor C1 is connected to the source terminal of the drive transistor TD since the switching transistor T4 is in a non-conducting state. The drain-source current of the drive transistor TD flows through the capacitor C1.

Accordingly, the capacitor C1 is charged, the voltage of the first terminal of the capacitor C1, that is, the voltage of the source terminal s of the drive transistor TD increases to finally reach Vdata−Vth. That is, when the voltage between the gate and source terminals of the drive transistor is equal to the threshold voltage Vth of the drive transistor TD, the drive transistor TD is in an OFF state.

As described above, the voltage of the source terminal s of the drive transistor TD is converged to the voltage Vdata−Vth which is dropped from the data voltage Vdata to the threshold voltage Vth, without the influence of the positive power source voltage VDD and the negative power source voltage VSS.

A voltage difference between this voltage and the reference voltage VR is held in the capacitor C1. The voltage held in the capacitor C1 is VR−(Vdata−Vth), and this voltage does not include the influence of the positive power source voltage VDD and the negative power source voltage VSS.

A light-emitting operation is performed in a light-emitting period after time t7.

(d) in FIG. 14 is a circuit diagram which explains the light-emitting operation. The switching transistors T1 and T3 which are in a non-conducting state in the light-emitting period are illustrated in a dotted line.

In the light-emitting period, the switching transistors T1 and T3 are in a non-conducting state and the switching transistor T2 is in a conducting state. Then, the voltage VR−(Vdata−Vth) held in the capacitor C1 is applied between the gate and source terminals of the driving transistor TD.

As a result, the voltage Isd=β/2×(VR−Vdata)² which has the precise magnitude and corresponds to the data voltage Vdata is provided from the drive transistor TD to the organic EL element EL, it is possible to cause the organic EL element to emit light at a precise luminance corresponding to the data voltage Vdata, without the influence of the change of the power source voltage.

Moreover, since, in the Vth detection period illustrated in (c) in FIG. 12 and (c) in FIG. 14, the capacitor C2 has a role in holding the gate voltage of the drive transistor TD, and in the light-emitting period in (d) in FIG. 12 and (d) in FIG. 14, the switching transistor T2 is in an ON state due to the signal line MERGE, the capacitor C1 only holds the gate voltage of the drive transistor TD. In other words, when the light-emitting period is set longer than the Vth detection period in order to increase the lifespan of the organic EL element EL by decreasing current density of the organic EL element EL in the light-emitting period, the time in which the capacitor C2 holds the voltage is shorter than the time in which the capacitor C1 holds the voltage. In other words, the capacitance of the capacitor C2 san be smaller than the capacitance of the capacitor C1.

With this, the capacitor C1 can secure an area larger than the capacitor C2, and it is possible to stabilize the current provided from the drive transistor TD to the organic EL element EL in the light-emitting period. In other words, the display image quality is increased.

### Embodiment 3

Embodiment 3 according to the present invention will be described with reference to the Drawings.

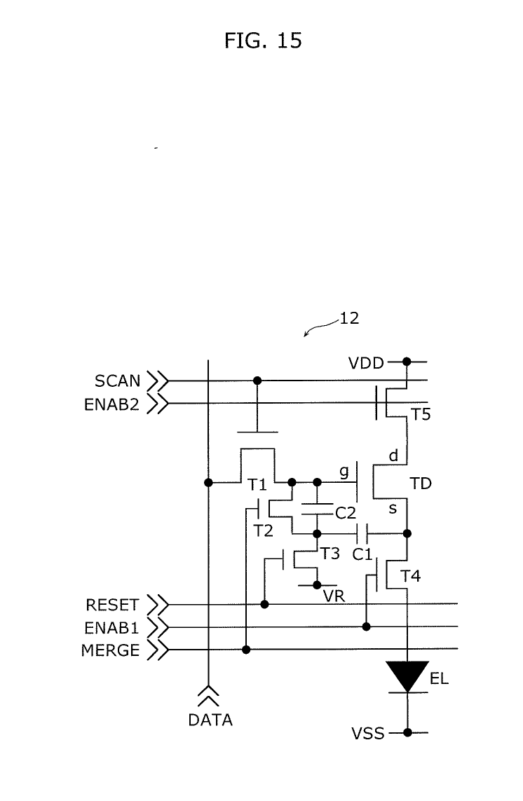

FIG. 15 is a circuit diagram illustrating an example of a configuration of a pixel circuit 12 according to Embodiment 3. The pixel circuit 12 is configured by adding, to the pixel circuit 11 in FIG. 8, the switching transistor T5. The signal line ENAB provided in each of the rows in the display unit 2 corresponding to the pixel circuit 12 is changed to two signal lines ENAB1 and ENAB2.

In the pixel circuit 12, the switching transistor T4 switches between conduction and non-conduction between the source terminal s of the driving transistor TD and the second terminal (at the top side of the illustration) of the organic EL element EL, according to the control signal transmitted by the signal line ENAB 1.

The switching transistor T5 is inserted between the power source line VDD and the drain terminal d of the drive transistor TD, and switches between conduction and non-conduction between the power source line VDD and the drain terminal d of the drive transistor TD, according to the control signal transmitted by the signal ENAB 2.

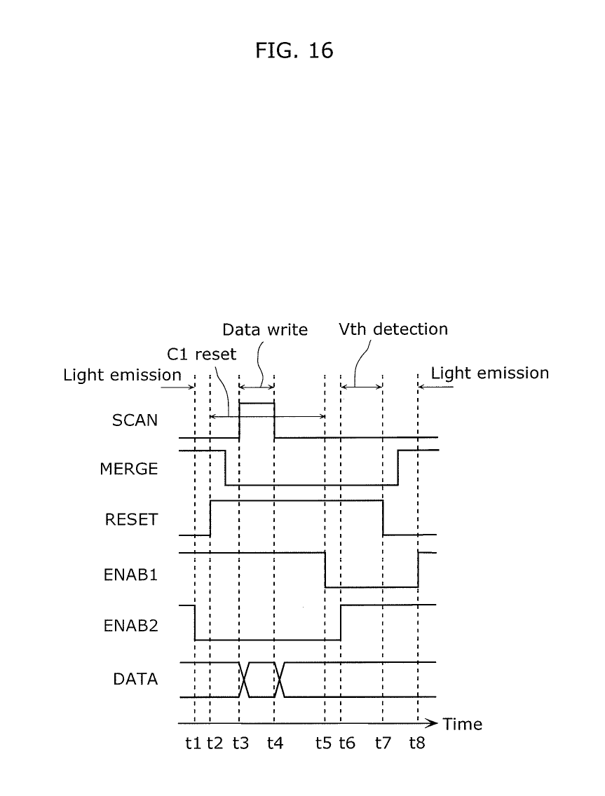

FIG. 16 is a timing chart illustrating an example of the control signal and the data signal for operating the pixel circuit 12, for one frame period. In FIG. 16, the vertical axis denotes the level of each signal, and the horizontal axis represents the passing of time.

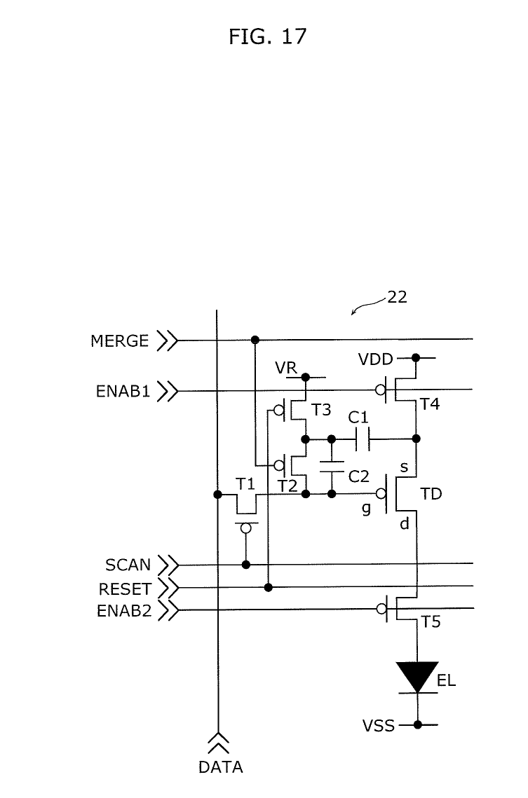

FIG. 17 is a circuit diagram illustrating an example of a configuration of a pixel circuit 22 according to Embodiment 3. The pixel circuit 22 is configured by adding, to the pixel circuit 21 in FIG. 10, the switching transistor T5. The signal line ENAB provided in each of the rows in the display unit 2 corresponding to the pixel circuit 22 is changed to two signal lines ENAB1 and ENAB2.

In the pixel circuit 22, the switching transistor T4 switches between conduction and non-conduction between the power source line VDD and the source terminal s of the driving transistor TD, according to the control signal transmitted by the signal line ENAB 1.

The switching transistor T5 is inserted between the drain terminal d of the drive transistor TD and the first terminal (at the top side of the illustration) of the organic EL element EL, and switches between conduction and non-conduction between the drain terminal d of the drive transistor TD and the first terminal of the organic EL element EL, according to the control signal transmitted by the ENAB2.

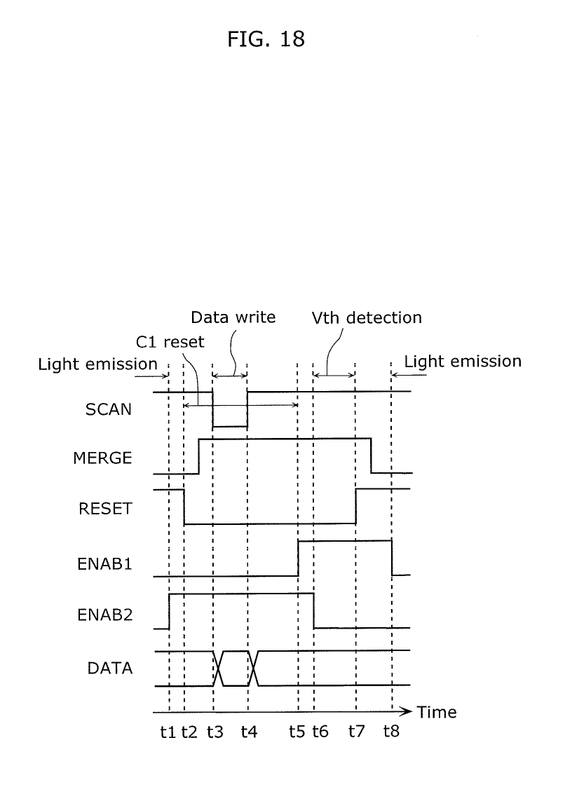

FIG. 18 is a timing chart illustrating an example of the control signal and the data signal for operating the pixel circuit 22, for one frame period. In FIG. 18, the vertical axis denotes the level of each signal, and the horizontal axis represents the passing of time.

The drive transistor TD, and the switching transistors T1 to T5 are configured of an n-type transistor in the pixel circuit 12, and configured of a p-type transistor in the pixel circuit 22. The pixel circuit 12 and the pixel circuit 22, illustrated in FIG. 16 and FIG. 18, respectively, perform the same operation when provided with control signals having respective levels obtained by simply reversing the levels of the control signals.

Compared with the operation of the pixel circuit 11 according to the control signal and the data signal illustrated in FIG. 13, the operation of the pixel circuit 12 according to the control signal and the data signal illustrated in FIG. 16 is common in that it is configured of the C1 reset operation, the data write operation, the Vth detection operation, and the light-emitting operation, but is different in that the C1 reset operation and the data write operation are performed when the switching transistor T5 is in a non-conducting state and the drain terminal of the drive transistor TD is electrically separated from the positive power source voltage VDD.

With this, in the C1 reset operation, the voltage at both ends of the capacitor C1 can be no less than the threshold voltage Vth of the drive transistor TD, without causing current to flow through the organic EL element EL. As a result, the unnecessary light emission of the organic EL element EL is reduced, and an advantageous effect of increasing a display contract can be obtained.

This can be applied to the operation of the pixel circuit 22 performed according to the control signal and the data signal illustrated in FIG. 18. In other words, in the operation of the pixel circuit 22 performed according to the control signal and the data signal illustrated in FIG. 18, the C1 reset operation and the data write operation are performed when the switching transistor T5 is in a non-conduction state and the drain terminal d of the drive transistor TD is electrically separated from the negative power source voltage VDD. As a result, as described above, the unnecessary light emission of the organic EL element EL is reduced, and an advantageous effect of increasing a display contract can be obtained.

Moreover, as similarly to Embodiment 2, the capacitance of the capacitor C2 can be smaller than the capacitance of the capacitor C1, the capacitor C1 can secure an area larger than the capacitor C2, and it is possible to stabilize the current provided from the drive transistor TD to the organic EL element EL in the light-emitting period. In other words, the display image quality is increased.

### Modification of Embodiment 3

Modification of Embodiment 3 according to the present invention will be described with reference to the Drawings. The present modification illustrates another example of an operation of each of the pixel circuits 11 and 22.

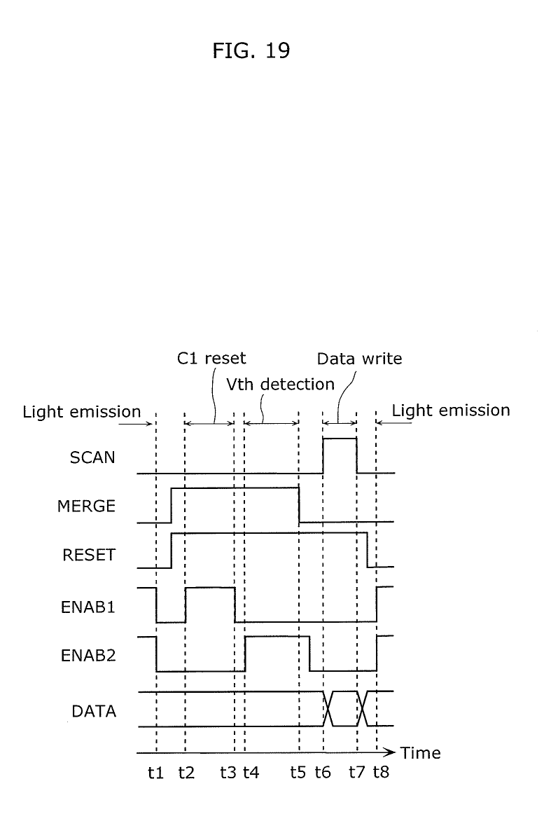

FIG. 19 is a timing chart illustrating an example of the control signal and the data signal for operating the pixel circuit 12, for one frame period.

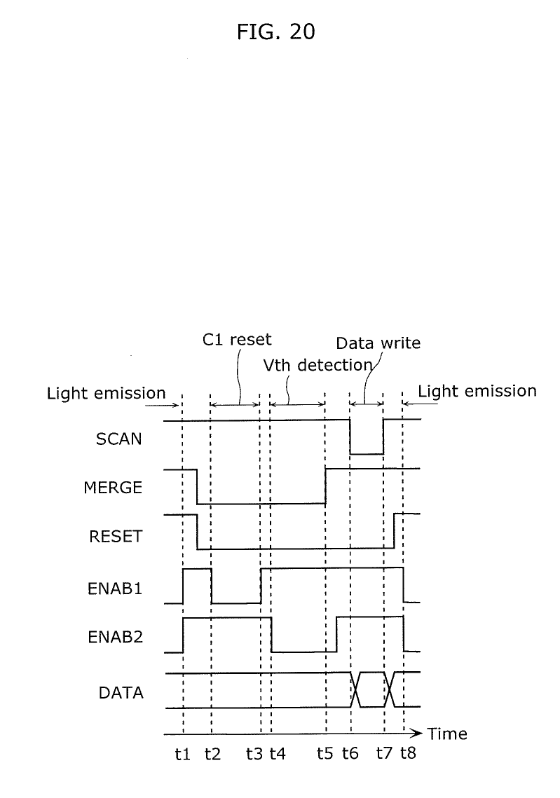

FIG. 20 is a timing chart illustrating an example of the control signal and the data signal for operating the pixel circuit 22, for one frame period.

In FIGS. 19 and 20, the vertical axis denotes the level of each signal, and the horizontal axis represents the passing of time. The control signal for operating the pixel circuit 22 illustrated in FIG. 20 is a control signal obtained by simply reversing the level of the control signal for operating the pixel circuit 12 illustrated in FIG. 19.

The operation of the pixel circuit 12 performed according to the control signal and the data signal illustrated in FIG. 19 will be described.

The light emission in the preceding frame ends at time t1.

A C1 reset operation is performed in a C1 reset period from time t2 to time t3.

In the C1 reset period, the switching transistors T3 and T4 are in a conducting state, the voltage of the second terminal of the capacitor C1 is set to the reference voltage VR, and the source voltage of the drive transistor TD which is the first terminal of the capacitor C1 is set to a voltage obtained by adding the OFF voltage of the organic EL element EL to the negative power source voltage VSS. With this, since the voltage of the capacitor C1 is initialized to the same voltage in every frame, the influence of the voltage in the preceding frame which remains in the capacitor C1 when the preceding frame ends is removed. At this time, since the switching transistor T2 is also in a conducting state, the voltage of the capacitor C2 is reset to 0.

The Vth detection operation is performed in the Vth detection period from time t4 to time t5.

In the Vth detection period, the switching transistor T4 is in a non-conducting state, and the source terminal s of the drive transistor TD is electrically separated from the negative power source voltage VSS. The switching transistors T2 and T3 are in a conducting state, and the reference voltage VR is applied to the gate terminal g of the drive transistor TD. As a result, the voltage of the source terminal s of the drive transistor TD is converged to the voltage VR−Vth which is dropped from the reference voltage CR to the threshold voltage Vth, without the influence of the negative power source voltage VSS.

A voltage difference between this voltage and the reference voltage VR is held in the capacitor C1. The voltage held in the capacitor C1 is VR−(VR−Vth)=Vth, and this voltage does not include the influence of the negative power source voltage VSS.

A data write operation is performed in a data write period from time t6 to time t7.

In the data write period, the switching transistors T1 and T3 are in a conducting state, the data voltage Vdata is obtained from the signal line DATA, and a voltage difference between the data voltage Vdata and the reference voltage VR is held in the capacitor C2.

A light-emitting operation is performed in a light-emitting period after time t8.

In the light-emitting period, the switching transistors T1 to T3 are in a non-conducting state, and the voltage (Vdata−VR)+Vth obtained by adding the voltage held in each of the capacitors C1 and C2 is applied between the gate and source terminals of the drive transistor TD.

As a result, the voltage Isd=β/2×(Vdata−VR)² which has a precise magnitude and corresponds to the data voltage Vdata is provided from the drive transistor TD to the organic EL element EL, it is possible to cause the organic EL element EL to emit light at a precise luminance corresponding to the data voltage Vdata, without the influence of a change of the power source voltage.

### Embodiment 4

Embodiment 4 according to the present invention will be described with reference to the Drawings.

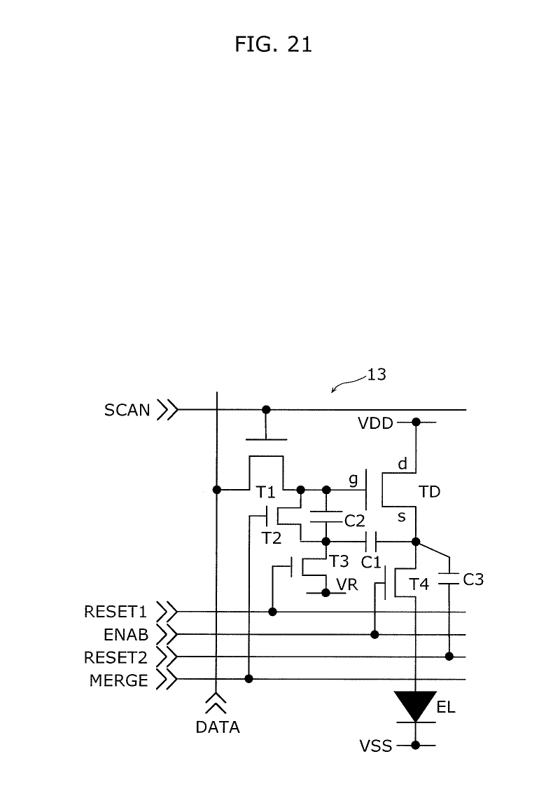

FIG. 21 is a circuit diagram illustrating an example of a configuration of a pixel circuit 13 according to Embodiment 4. The pixel circuit 13 is configured by adding, to the pixel circuit 11 in FIG. 8, the capacitor C3. The signal line RESET provided in each of the rows in the display unit 2 corresponding to the pixel circuit 13 is changed to two signal lines RESET1 and RESET2.

In the pixel circuit 13, the switching transistor T3 switches between conduction and non-conduction between the second terminal (at the left side of the illustration) of the capacitor C1 and the reference voltage line VR, according to the control signal transmitted by the signal line RESET.

The capacitor C1 has a first terminal (at the top side of the illustration) which is connected to the source terminal s of the drive transistor TD, and a second terminal (at the bottom side of the illustration) which is connected to the signal line RESET2.

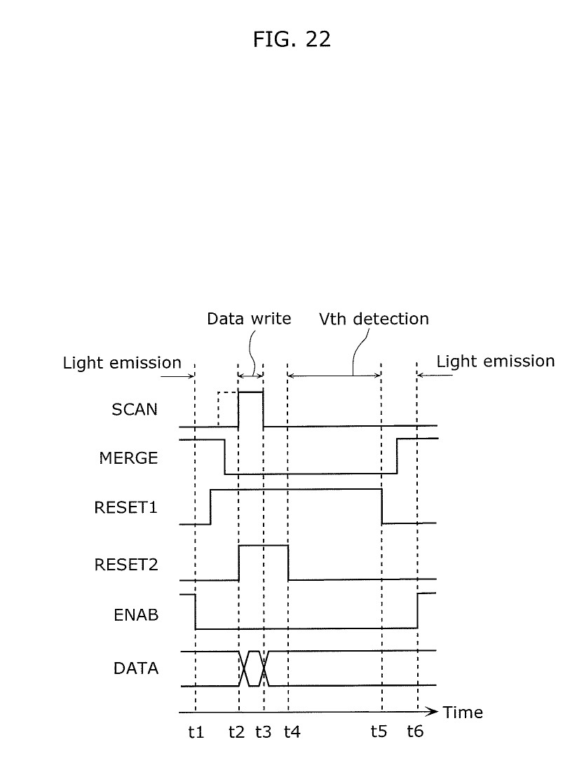

FIG. 22 is a timing chart illustrating an example of the control signal and the data signal for operating the pixel circuit 13, for one frame period. In FIG. 22, the vertical axis denotes the level of each signal, and the horizontal axis represents the passing of time.

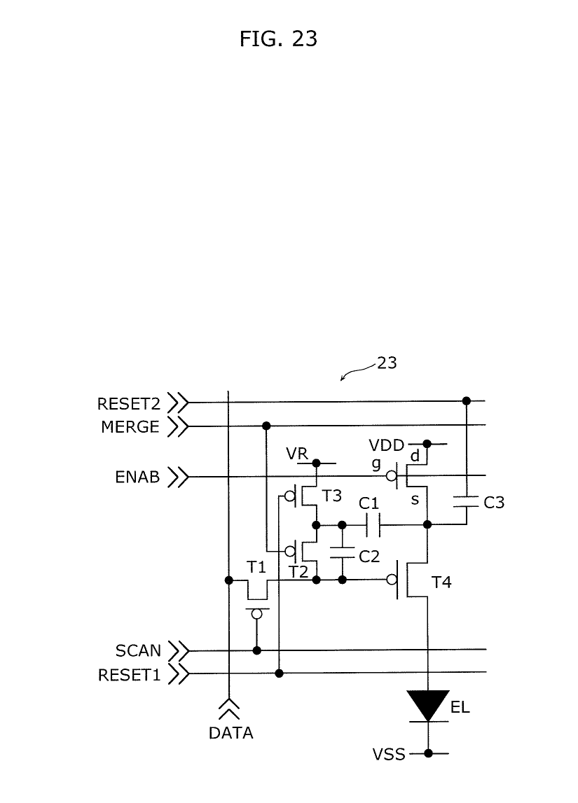

FIG. 23 is a circuit diagram illustrating an example of a configuration of a pixel circuit 23 according to Embodiment 4. The pixel circuit 23 is configured by adding, to the pixel circuit 21 in FIG. 10, the capacitor C3. The signal line RESET provided in each of the rows in the display unit 2 corresponding to the pixel circuit 23 is changed to two signal lines RESET1 and RESET2.

In the pixel circuit 23, the switching transistor T3 switches between conduction and non-conduction between the second terminal (at the left side of the illustration) of the capacitor C1 and the reference voltage line VR, according to the control signal transmitted by the signal line RESET1.

The capacitor C3 has a first terminal (at the bottom side of the illustration) which is connected to the source terminal s of the drive transistor TD, and a second terminal (at the top side of the illustration) which is connected to the signal line RESET2.

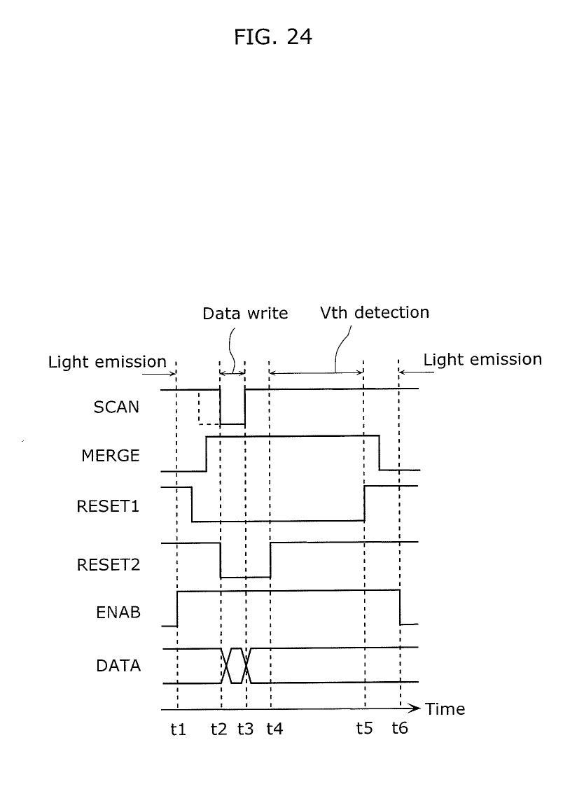

FIG. 24 is a timing chart illustrating an example of the control signal and the data signal for operating the pixel circuit 23, for one frame period. In FIG. 24, the vertical axis denotes the level of each signal, and the horizontal axis represents the passing of time.

The drive transistor TD, and the switching transistors T1 to T5 are configured of an n-type transistor in the pixel circuit 13, and configured of a p-type transistor in the pixel circuit 23. The pixel circuit 13 and the pixel circuit 23, illustrated in FIG. 22 and FIG. 24, respectively, perform the same operation when provided with control signals having respective levels obtained by simply reversing the levels of the control signals.

The operation of the pixel circuit 13 performed according to the control signal and the data signal illustrated in FIG. 22 will be described.

The light emission in the preceding frame ends at time t1.

A data write operation is performed in a data write period from time t2 to time t3.

In the data write period, the switching transistors T1 and T3 are in a conducting state, the data voltage Vdata is obtained from the signal line DATA, and a voltage difference between the data voltage Vdata and the reference voltage VR is held in the capacitor C2.

The Vth detection operation is performed in the Vth detection period from time t4 to time t5.

In the Vth detection period, the switching transistor T4 is in a non-conducting state, and the source terminal s of the drive transistor TD is electrically separated from the negative power source voltage VSS. The data voltage Vdata held in the capacitor C2 is applied to the gate terminal g of the drive transistor TD. Moreover, the positive power source voltage VDD is set to a voltage higher than the voltage obtained by adding, to the highest voltage of the signal line DATA, the largest value of the threshold voltage Vth in the drive transistor TD of all the pixels.

At time t4, RESET2 falls from HIGH to LOW. When the voltage fluctuation amount of RESET2 is ΔVrst, the voltage of the source terminal s of the drive transistor TD is Vso−ΔVrst−C3/(C1+C3) where it is Vso (VDD≧Vso) just before t4. Here, the amplitude of the falling voltage ΔVrst of RESET2 is set to Vdata−Vso+ΔVrst·C3/(C1+C3)≧Vth.

Since the voltage between the gate and source terminals of the drive transistor TD is larger than the threshold voltage Vth, the drive transistor is in a conducting state and then a current flows from the drain terminal to the source terminal of the drive transistor TD.

Since, at this time, the switching transistor T4 is in a non-conducting state, the drain-source current of the drive transistor TD flows through the capacitors C1 and C3, and the organic EL element EL does not emit light because the current is not provided to the organic EL element EL.

Accordingly, the capacitors C1 and C3 are charged, the voltage of the first terminal of the capacitor C1, that is, the voltage of the source terminal s of the drive transistor TD increases to finally reach Vdata−Vth. That is, when the voltage between the gate and source terminals of the drive transistor TD is equal to the threshold voltage Vth of the drive transistor TD, the drive transistor TD is in an OFF state.

As a result, the voltage of the source terminal s of the drive transistor TD is converged to the voltage Vdata−Vth which is dropped from the data voltage Vdata to the threshold voltage Vth, without the influence of the positive power source voltage VDD and the negative power source voltage VSS.

A voltage difference between this voltage and the reference voltage VR is held in the capacitor C1. The voltage held in the capacitor C1 is VR−(Vdata−Vth), and this voltage does not include the influence of the positive power source voltage VDD and the negative power source voltage VSS.

A light-emitting operation is performed in a light-emitting period after time t7.

In the light-emitting period, the switching transistors T1 and T3 are in a non-conducting state and the switching transistor T2 is in a conducting state. Then, the voltage VR−(Vdata−Vth) held in the capacitor C1 is applied between the gate and source terminals of the driving transistor TD.

As a result, the voltage Isd=β/2×(VR−Vdata)² which has the precise magnitude and corresponds to the data voltage Vdata is provided from the drive transistor TD to the organic EL element EL, it is possible to cause the organic EL element EL to emit light at a precise luminance corresponding to the data voltage Vdata, without the influence of the change of the power source voltage.

It should be noted that, in the pixel circuits 13 and 23, the following modifications are possible.

For example, one signal line may serve as both the signal lines RESET2 and SCAN which transmit the control signal having a similar waveform.

Moreover, for example, the time when the control signal transmitted by the signal line SCAN is active (High level in FIG. 22, Low level in FIG. 24) may be extended by no less than one time the data write period, as illustrated in a dotted line in FIGS. 22 and 24. For example, when the time when the control signal transmitted by the signal line SCAN is active is set to the length twice that of the data write period, the extended part is equal to the data write period of the pixel circuit whish is disposed in an adjacent row. Therefore, since the magnified control signal transmitted by the signal line SCAN and the control signal transmitted by RESET 2 which is a signal line in the adjacent row have the same waveform, one signal line may serve as both the signal line SCAN and RESET2 which is a signal line in the adjacent row.

Since the use of the signal line for multiple purposes can reduce the footprint of a signal line, the use of the signal line for multiple purposes increases the arrangement density of each of the pixel circuits 13 and 23 and contributes to realizing a high-definition display device. Moreover, since the number of outputs of the scanning line drive circuit 4 can be decreased, the circuit size can be reduced and a cost can be decreased.

Moreover, as similarly to Embodiment 2, the capacitance of the capacitor C2 can be smaller than the capacitance of the capacitor C1, the capacitor C1 can secure an area larger than the capacitor C2, and it is possible to stabilize the current provided from the drive transistor TD to the organic EL element EL in the light-emitting period. In other words, the display image quality is increased.

### Embodiment 5

Embodiment 5 according to the present invention will be described with reference to the Drawings.

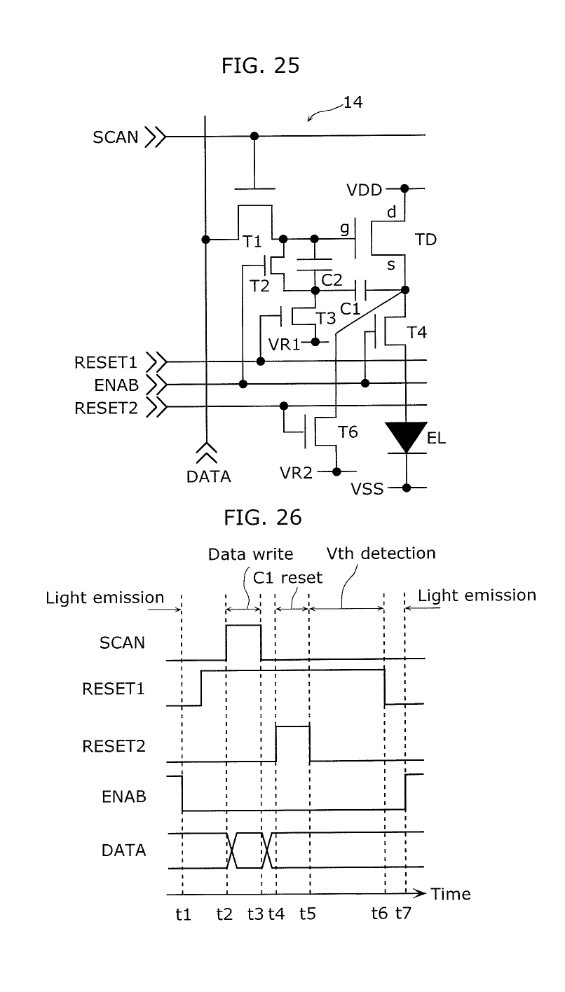

FIG. 25 is a circuit diagram illustrating an example of a configuration of a pixel circuit 14 according to Embodiment 5. The pixel circuit 14 is configured by adding, to the pixel circuit 11 in FIG. 8, the switching transistor T6. The signal line RESET provided in each of the rows in the display unit 2 corresponding to the pixel circuit 14 is changed to two signal lines RESET1 and RESET2, and the signal lines MERGE and ENAB provided in each of the rows are served by the one signal line ENAB. Moreover, the reference voltage line VR in the display unit 2 is changed to two reference voltage lines VR1 and VR2.

It should be noted that the signal lines MERGE and ENAB may be provided independently. When the signal lines MERGE and ENAB are provided independently, the switching transistor T6 may be connected to the reference voltage line VR2 and the second terminal of the organic EL element EL. With this, a voltage reset operation of the organic EL element EL is possible, and by applying a reverse bias voltage to the organic EL element EL, degradation of the organic EL element EL can be reduced.

In the pixel circuit 14, the switching transistor T3 switches between conduction and non-conduction between the second terminal (at the left side of the illustration) of the capacitor C1 and the reference voltage line VR1, according to the control signal transmitted by the signal line RESET1.

The switching transistor T2 switches between conduction and non-conduction between the gate terminal g of the driving transistor TD and the second terminal of the capacitor C1, according to the control signal transmitted by the signal line ENAB.

The switching transistor T6 is inserted between the reference voltage line VR2 and the source terminal s of the drive transistor TD, and then switches between conduction and non-conduction between the reference voltage line VR2 and the source terminal s of the drive transistor TD, according to the control signal transmitted by the signal line RESET2.

FIG. 26 is a timing chart illustrating an example of the control signal and the data signal for operating the pixel circuit 14, for one frame period. In FIG. 26, the vertical axis denotes the level of each signal, and the horizontal axis represents the passing of time.

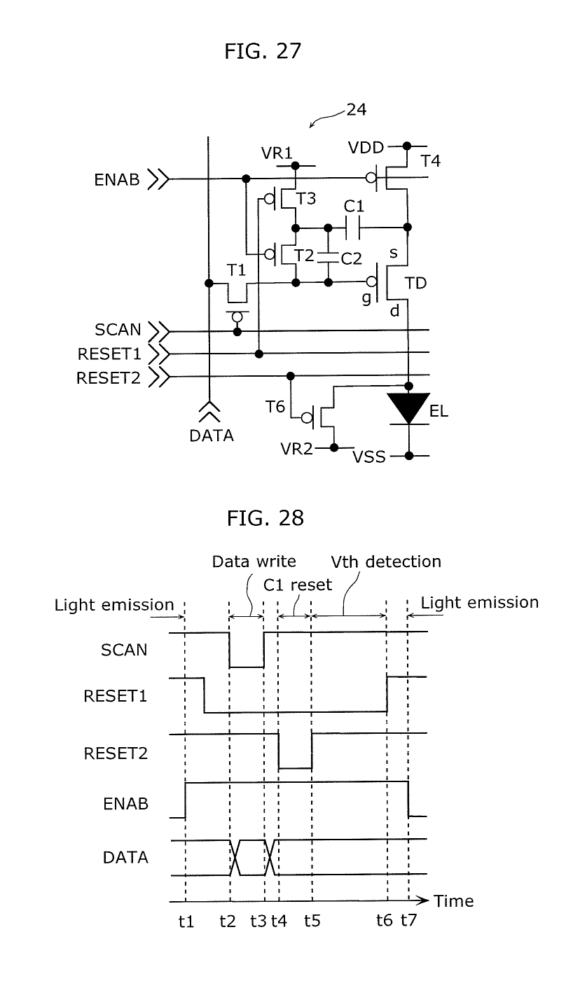

FIG. 27 is a circuit diagram illustrating an example of a configuration of a pixel circuit 24 according to Embodiment 5. The pixel circuit 24 is configured by adding, to the pixel circuit 21 in FIG. 10, the switching transistor T6. The signal line RESET provided in each of the rows in the display unit 2 corresponding to the pixel circuit 14 is changed to two signal lines RESET1 and RESET2, and the signal lines MERGE and ENAB provided in each of the rows are served by the one signal line ENAB. Moreover, the reference voltage line VR in the display unit 2 is changed to two reference voltage lines VR1 and VR2.

In the pixel circuit 24, the switching transistor T3 switches between conduction and non-conduction between the second terminal (at the left side of the illustration) of the capacitor C1 and the reference voltage line VR, according to the control signal transmitted by the signal line RESET1.

The switching transistor T2 switches between conduction and non-conduction between the gate terminal g of the driving transistor TD and the second terminal of the capacitor C1, according to the control signal transmitted by the signal line ENAB.

The switching transistor T6 is inserted between the reference voltage line VR2 and the first terminal (at the top side of the illustration) of the organic EL element EL, and then switches between conduction and non-conduction between the reference voltage line VR2 and the first terminal of the organic EL element EL, according to the control signal transmitted by the signal line RESET2.

FIG. 28 is a timing chart illustrating an example of the control signal and the data signal for operating the pixel circuit 23, for one frame period. In FIG. 28, the vertical axis denotes the level of each signal, and the horizontal axis represents the passing of time.

The drive transistor TD, and the switching transistors T1 to T4, and T6 are configured of an n-type transistor in the pixel circuit 14, and configured of a p-type transistor in the pixel circuit 24. The pixel circuit 14 and the pixel circuit 24, illustrated in FIG. 26 and FIG. 28, respectively, perform the same operation when provided with control signals having respective levels obtained by simply reversing the levels of the control signals.

The operation of the pixel circuit 14 performed according to the control signal and the data signal illustrated in FIG. 26 will be described.

The light emission in the preceding frame ends at time t1.

A data write operation is performed in a data write period from time t2 to time t3.

In the data write period, the switching transistors T1 and T3 are in a conducting state, the data voltage Vdata is obtained from the signal line DATA, and a voltage difference between the data voltage Vdata and the reference voltage VR is held in the capacitor C2.

A C1 reset operation is performed in a C1 reset period from time t1 to time t5.

In the C1 reset period, the switching transistors T3 and T6 are in a conducting state, the second terminal of the capacitor C1 is set to the reference voltage VR1, and the first terminal of the capacitor C1 is set to the reference voltage VR2. With this, since the voltage of the capacitor C1 is initialized to the same voltage in every frame, the influence of the voltage in the preceding frame which remains in the capacitor C1 when the preceding frame ends is removed. Here, the reference voltages VR1 and VR2 are set to VR1−VR2≧Vth. Since, at this time, the drive transistor TD is in an ON state but the switching transistor T4 is in a non-conducting state, the organic EL element EL does not emit light because a current is not provided to the organic EL element EL.

The Vth detection operation is performed in the Vth detection period from time t5 to time t6.

In the Vth detection period, the switching transistors T4 and T6 are in a non-conducting state, and the source terminal s of the drive transistor TD is electrically separated from the negative power source voltage VSS. The data voltage Vdata held in the capacitor C2 is applied to the gate terminal g of the drive transistor TD. Moreover, the positive power source voltage VDD is set to a voltage higher than the voltage obtained by adding, to the highest voltage of the signal line DATA, the largest value of the threshold voltage Vth in the drive transistor TD of all the pixels.

As a result, since, in the Vth detection period, the drive transistor TD inevitably operates in a saturated region, the drain-source current of the drive transistor TD is controlled only by the voltage between the drain and source terminals. Since the gate terminal g of the drive transistor TD is currently fixed to the data voltage Vdata, the drain-source current of the drive transistor TD is controlled by the voltage of the source terminal s.

Since the switching transistors T4 and T6 are in a non-conducting state, only the first terminal of the capacitor C1 is connected to the source terminal of the drive transistor TD. The drain-source current of the drive transistor flows through the capacitor C1. Accordingly, the capacitor C1 is charged, the voltage of the first terminal of the capacitor C1, that is, the voltage of the source terminal s of the drive transistor TD increases to finally reach Vdata−Vth. That is, when the voltage between the gate and source terminals of the drive transistor is equal to the threshold voltage Vth of the drive transistor TD, the drive transistor TD is in an OFF state.

As described above, the voltage of the source terminal of the drive transistor TD is converged to the voltage Vdata−Vth which is dropped from the data voltage Vdata to the threshold voltage Vth, without the influence of the positive power source voltage VDD and the negative power source voltage VSS.

A voltage difference between this voltage and the reference voltage VR1 is held in the capacitor C1. The voltage held in the capacitor C1 is VR1−(Vdata−Vth), and this voltage does not include the influence of the positive power source voltage VDD and the negative power source voltage VSS.

A light-emitting operation is performed in a light-emitting period after time t7.

In the light-emitting period, the switching transistors T1 and T3 are in a non-conducting state, the switching transistor T2 is in a conducting state, and the voltage VR1−(Vdata−Vth) held in the capacitor C1 is applied between the gate and source of the drive transistor TD.

As a result, the voltage Isd=β/2×(VR1−Vdata)² which has a precise magnitude and corresponds to the data voltage Vdata is provided from the drive transistor TD to the organic EL element EL, it is possible to cause the organic EL element EL to emit light at a precise luminance corresponding to the data voltage Vdata, without the influence of the change of the power source voltage.

It should be noted that, in the pixel circuits 14 and 24, the following modifications are possible.

For example, by configuring the switching transistor T3 of a p-type transistor in a pixel circuit 14 and of an n-type transistor in the pixel circuit 24, the signal lines RESET1 and ENAB may be served by one signal line.

Moreover, for example, since when the data write period is equal to the C1 reset period of the pixel circuit disposed in an adjacent row, the control signal transmitted by the signal line SCAN and the control signal transmitted by RESET 2 which is a signal line in the adjacent row have the same waveform. Therefore, one signal line may serve as both the signal line SCAN and RESET2 which is a signal line in the adjacent row.

Since the use of the signal line for multiple purposes can reduce the footprint of a signal line, the use of the signal line for multiple purposes increases the arrangement density of each of the pixel circuits 14 and 24 and contributes to realizing a high-definition display device. Moreover, since the number of outputs of the scanning line drive circuit 4 can be decreased, the circuit size can be reduced and a cost can be decreased.

Moreover, as similarly to Embodiment 2, the capacitance of the capacitor C2 can be smaller than the capacitance of the capacitor C1, the capacitor C1 can secure an area larger than the capacitor C2, and it is possible to stabilize the current provided from the drive transistor TD to the organic EL element EL in the light-emitting period. In other words, the display image quality is increased.

Although the display device and the control method thereof according to the present invention, particularly the pixel circuit used in the display device and the operation thereof, have been described based on the embodiments and the modifications, the present invention is not limited to such embodiments and modifications. Display devices and control methods thereof resulting from various modifications of the exemplary embodiment as well arbitrary combinations of constituent components of the exemplary embodiment that may be conceived by those skilled in the art, for as long as these do not depart from the essence of the present invention, are intended to be included within the scope of the present invention.

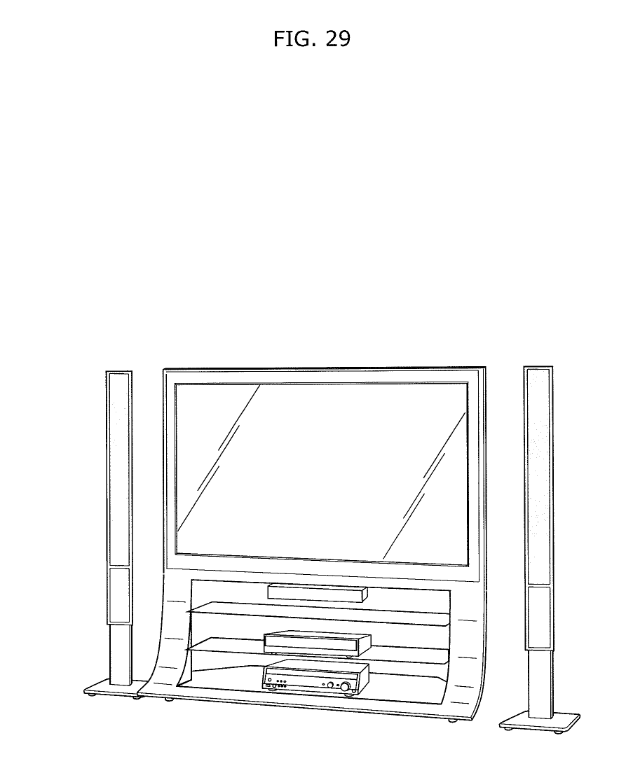

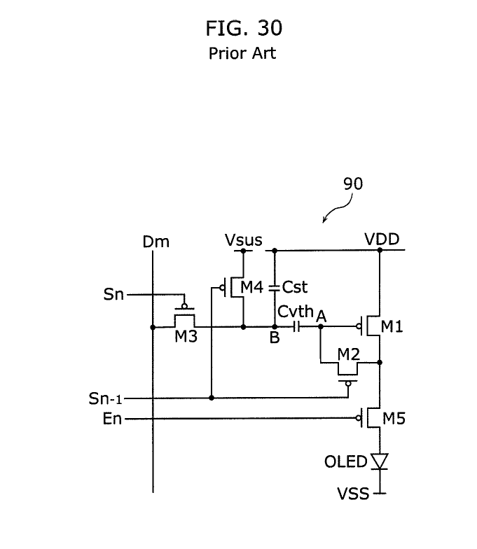

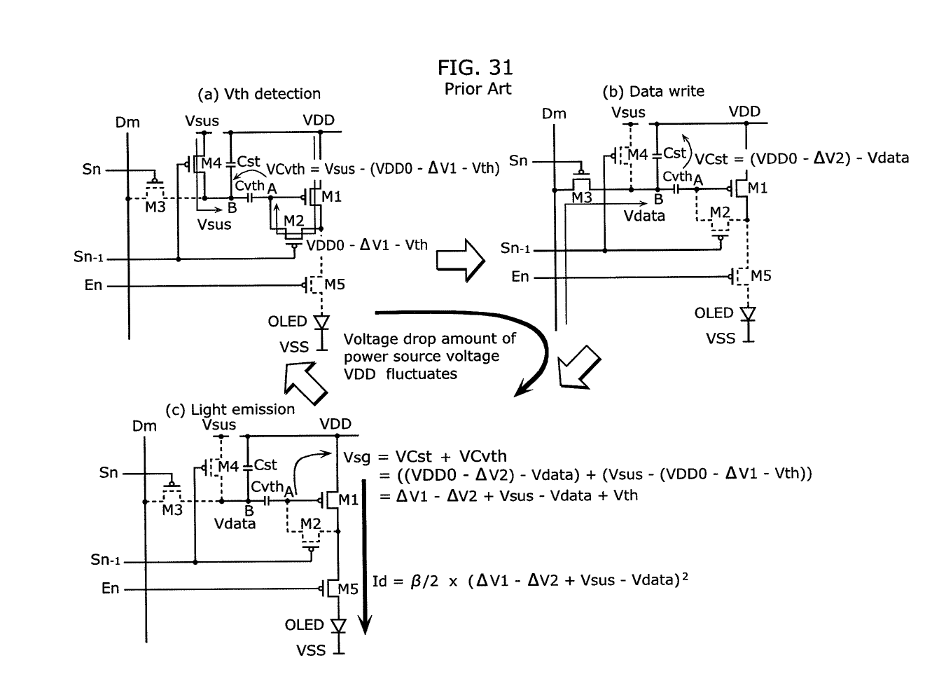

The display device according to the present invention may include a thin flat-screen TV as illustrated in FIG. 29. By including the display device according to the present invention, it is possible to realize a thin flat-screen TV which is capable of display an image represented by the video signal at a high definition.

### INDUSTRIAL APPLICABILITY

The present invention is useful in display device using organic EL elements, and is particularly useful in an active-matrix organic EL display device.

### REFERENCE SIGNS LIST

1 Display device
2 Display unit
3 Control circuit
4 Scanning line drive circuit
5 Signal line control circuit
6 Power source circuit
10 to 14, 20 to 24, 90 Pixel circuit
TD Drive transistor
T1 to T6 Switching transistor
C1, C2 Capacitor
EL Organic EL element

1-16. (canceled)

17. A display device comprising a display unit including pixel circuits,
each of the pixel circuits including:
a drive transistor;
a first capacitive element having a first terminal connected to a source terminal of the drive transistor;
a first switching element which switches between conduction and non-conduction between a gate terminal of the drive transistor and a data line transmitting a data voltage corresponding to luminance;
a second switching element which switches between conduction and non-conduction between the gate terminal of the drive transistor and a second terminal of the first capacitive element;
a third switching element which switches between conduction and non-conduction between the second terminal of the first capacitive element and a reference voltage line transmitting a constant reference voltage;
a fourth switching element which switches between conduction and non-conduction between a first power source line transmitting a first power source voltage and the source terminal of the drive transistor; and
a light-emitting element having a first terminal connected to a drain terminal of the drive transistor and a second terminal connected to a second power source line transmitting a second power source voltage,
wherein, in each of the pixel circuits, while a threshold voltage of the drive transistor is being detected by placing the fourth switching element in a non-conducting state and by placing the third switching element in a conducting state, the data voltage is written from the data line by placing the second switching element in a non-conducting state and by placing the first switching element in a conducting state.

18. The display device according to claim 17,
wherein each of the pixel circuits includes only the first capacitive element as a capacitive element.

19. The display device according to claim 17,
wherein, in each of the pixel circuits, each of the first switching element and the third switching element is a double-gate thin-film transistor.

20. The display device according to claim 19,
wherein, in each of the pixel circuits, the second switching element is a double-gate thin-film transistor.

21. A display device comprising a display unit including pixel circuits,
each of the pixel circuits including:
a drive transistor having a drain terminal connected to a first power source line transmitting a first power source voltage;
a first capacitive element having a first terminal connected to a source terminal of the drive transistor;
a first switching element which switches between conduction and non-conduction between a gate terminal of the drive transistor and a data line transmitting a data voltage corresponding to luminance;
a second switching element which switches between conduction and non-conduction between the gate terminal of the drive transistor and a second terminal of the first capacitive element;
a third switching element which switches between conduction and non-conduction between the second terminal of the first capacitive element and a reference voltage line transmitting a constant reference voltage;
a light-emitting element having a first terminal connected to a second power source line transmitting a second power source voltage; and
a fourth switching element which switches between conduction and non-conduction between the source terminal of the drive transistor and a second terminal of the light-emitting element,
wherein, in each of the pixel circuits, while a threshold voltage of the drive transistor is being detected by placing the fourth switching element in a non-conducting state and by placing the third switching element in a conducting state, the data voltage is written from the data line by placing the second switching element in a non-conducting state and by placing the first switching element in a conducting state.

22. The display device according to claim 21,
wherein each of the pixel circuits includes only the first capacitive element as a capacitive element.

23. The display device according to claim 21,
wherein, in each of the pixel circuits, each of the first switching element and the third switching element is a double-gate thin-film transistor.

24. The display device according to claim 23,
wherein, in each of the pixel circuits, the second switching element is a double-gate thin-film transistor.

25. A control method of a display device,
the display device comprising a display unit including pixel circuits,
each of the pixel circuits including:
a drive transistor;
a first capacitive element having a first terminal connected to a source terminal of the drive transistor;
a first switching element which switches between conduction and non-conduction between a gate terminal of the drive transistor and a data line transmitting a data voltage corresponding to luminance;
a second switching element which switches between conduction and non-conduction between the gate terminal of the drive transistor and a second terminal of the first capacitive element;
a third switching element which switches between conduction and non-conduction between the second terminal of the first capacitive element and a reference voltage line transmitting a constant reference voltage;
a fourth switching element which switches between conduction and non-conduction between a first power source line transmitting a first power source voltage and the source terminal of the drive transistor; and
a light-emitting element having a first terminal connected to a drain terminal of the drive transistor, and having a second terminal connected to a second power source line transmitting a second power source voltage,
the control method comprising, in each of the pixel circuits, writing the data voltage from the data line by placing the second switching element in a non-conducting state and by placing the first switching element in a conducting state, while detecting a threshold voltage of the drive transistor by placing the fourth switching element in a non-conducting state and by placing the third switching element in a conducting state.

26. The control method of the display device according to claim 25, further comprising
providing, in each of the pixel circuits, a current from the drive transistor to the light-emitting element, by placing the fourth switching element in a conducting state, and by applying a bias voltage corresponding to the data voltage Vdata and corrected by the threshold voltage Vth, between a gate terminal and a source terminal of the drive transistor.

27. A control method of a display device,
the display circuit comprising a display unit including pixel circuits,
each of the pixel circuits including:
a drive transistor having a drain terminal connected to a first power source line transmitting a first power source voltage;
a first capacitive element having a first terminal connected to a source terminal of the drive transistor;
a first switching element which switches between conduction and non-conduction between a gate terminal of the drive transistor and a data line transmitting a data voltage corresponding to luminance;
a second switching element which switches between conduction and non-conduction between the gate terminal of the drive transistor and a second terminal of the first capacitive element;
a third switching element which switches between conduction and non-conduction between the second terminal of the first capacitive element and a reference voltage line transmitting a constant reference voltage;
a light-emitting element having a first terminal connected to a second power source line transmitting a second power source voltage; and
a fourth switching element which switches between conduction and non-conduction between the source terminal of the drive transistor and a second terminal of the light-emitting element,
the control method comprising, in each of the pixel circuits, writing the data voltage from the data line by placing the second switching element in a non-conducting state and by placing the first switching element in a conducting state, while detecting a threshold voltage of the drive transistor by placing the fourth switching element in a non-conducting state and by placing the third switching element in a conducting state.

28. The control method of the display device according to claim 27, further comprising
providing, in each of the pixel circuits, a current from the drive transistor to the light-emitting element, by placing the fourth switching element in a conducting state, and by applying a bias voltage corresponding to the data voltage Vdata and corrected by the threshold voltage Vth, between the gate terminal and the source terminal of the drive transistor.
